(19) United States
(12) Patent Application Publication
(10) Pub. No.: US 2024/0213800 A1
(43) Pub. Date: Jun. 27, 2024

(54) SMART GRID DISTRIBUTED OPERATIONS PLATFORM

(71) Applicant: Utilidata, Inc., Providence, RI (US)

(72) Inventors: Marissa Hummon, Golden, CO (US); Brandon Thayer, Spokane, WA (US); Rick Steuer, Kansas City, MT (US); Karen Studarus, Seattle, WA (US); Matt Taylor, Town, ME (US); Bill Schroeder, Milwaukee, WI (US); Taylor Spalt, Richmond, VA (US)

(73) Assignee: Utilidata, Inc., Providence, RI (US)

(21) Appl. No.: 18/394,058

(22) Filed: Dec. 22, 2023

Related U.S. Application Data
(60) Provisional application No. 63/435,172, filed on Dec. 23, 2022.

(51) Int. Cl. H02J 13/00; H04L 9/40

(52) U.S. Cl. CPC H02J 13/00026; H02J 13/00017; H04L 63/10

(57) ABSTRACT

Systems and methods for a smart grid distributed operations platform. The system can include a data processing system comprising one or more processors, coupled with memory. The data processing system can identify a network connection with edge devices located on an electricity distribution grid, wherein each of the edge devices comprise a processor and memory. The data processing system can identify, based on a configuration associated with the edge devices, an application configured to perform a function to manage delivery of electricity via the electricity distribution grid. The data processing system can select a model from models trained with machine learning based on a local environment attribute associated with a location on the electricity distribution grid at which the edge devices are located. The data processing system can provide, for execution on the edge devices, the application configured with the model to perform the function to manage delivery of electricity.

### CROSS-REFERENCES TO RELATED APPLICATIONS

This application claims the benefit of priority under 35 U.S.C. § 119 to U.S. Provisional Patent Application No. 63/435,172, filed Dec. 23, 2022, which is hereby incorporated by reference herein in its entirety.

### FIELD OF THE DISCLOSURE

This disclosure relates generally to systems and methods for a smart grid distributed operations platform.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

The utility distribution grids can use meters to observe or measure utility delivery or consumption in the grid. These meters, among other components within utility distribution grids, can collect samples of power delivery or consumption, such as voltage information, at a sample rate (e.g., one sample every 15 to 60 minutes). The utility distribution grids (e.g., electrical distribution systems) can include distributed energy resources (DERs), such as photovoltaics (PV), energy storage systems (ESS), electric vehicles (EVs), and other electric generators or electric storage. These DERs can assist with the distribution of electricity, thereby allowing a decentralized, bidirectional smart grid. For decentralized, bidirectional smart utility grids, it can be challenging to manage the changing load characteristics of the enhanced power ecosystem using load prediction, DER balancing, or data collection of certain systems. To manage the changing load characteristics of these electrical distribution systems, the technical solution can provide at least one edge device (e.g., or electric consumption entities at the grid edge) capable of handling data processing operations (e.g., grid edge intelligence) at the edge of the utility distribution grid to optimize the configurations or decisions (e.g., adjustment of electrical input or output) for the DERs in real-time, allow for intelligent visualization of the electrical conditions at the grid edge (e.g., capabilities for acquiring the statuses or event information associated with the utility distribution grid and presenting the information to the users), and provide capabilities or supports for integrating one or more applications, such as third-party applications, from various application developers to one or more edge devices, among other non-limiting features or functionalities.

The grid edge intelligence can allow grid operators to effectively manage load or adjust the value of DERs, such as increasing or decreasing electrical output or input. This technology can include or utilize a distributed internet-of-things (IOT) computing platform capable of at least one of deploying or updating machine learning (ML) models at the grid edge to allow a decentralized, bidirectional, DER-integrated utility grid.

Therefore, the systems and methods of the technical solution can include a smart grid distributed operations platform (SGDOP) to provide the capabilities of the grid edge intelligence (e.g., metering devices or advance metering infrastructure (AMI) meter technology) and the distributed IoT computing platform for managing the load or adjusting the DER values for the utility grid. Each metering device can capture or obtain data in relatively real-time. The metering device can include a graphic processing unit (GPU) configured to process collected data, thereby combining metrology and GPU processing capability to enable distributed edge computing or learning. The SGDOP can include an (open-) IoT platform, allowing the deployment and management of software applications for the metering devices. For example, the SGDOP can combine the capabilities for utility usage of IoT that leverages the metering device (or other edge devices) as the edge compute-surface (e.g., surface computer) and augment the metering device capabilities with GPU capabilities to enable distributed artificial intelligence (AI) for at least managing various components within the utility grid, including but not limited to the DERs within the utility grid, such as PV, ESS, EVs (e.g., charging infrastructure or power distributor), or other electric generators or electric storage, providing visualization of the electrical condition (or other information related to the utility grid) at the grid edge, or providing the capabilities to support or integrate one or more applications from various (e.g., third-party) application developers, such as to the one or more edge devices. Hence, the deployment of the SGDOP can improve at least load management and DER value adjustment for the decentralized, bidirectional, DER-integrated utility grid.

This disclosure is directed to a system for a smart grid distributed operations platform. The system can include a data processing system comprising one or more processors, coupled with memory. The data processing system can identify a network connection with a plurality of edge devices located on an electricity distribution grid, wherein each of the plurality of edge devices comprise a processor and memory. The data processing system can identify, based on a configuration associated with the plurality of edge devices, an application configured to perform a function to manage delivery of electricity via the electricity distribution grid. The data processing system can select a model from a plurality of models trained with machine learning based on a local environment attribute associated with a location on the electricity distribution grid at which the plurality of edge devices are located. The data processing system can provide, for execution on the plurality of edge devices, the application configured with the model to perform the function to manage delivery of electricity via the electricity distribution grid.

The data processing system can determine a data security policy based on the configuration. The data processing system can set the application with the data security policy, wherein the data security policy controls access to a type of data, a type of metric, or a type of function. The application can filter data transmitted to the data processing system using the data security policy.

The data processing system can identify a second application installed on the plurality of edge devices. The data processing system can provide an instruction to the application to cause the application to output data to the second application to perform one or more functions to manage delivery of electricity via the electricity distribution grid.

The data processing system can identify a second application installed on the plurality of edge devices. The data processing system can update a configuration of the second application based on output from the application.

The data processing system can receive a data stream from at least one of the plurality of edge devices. The data processing system can generate an electricity utilization metric based on the data stream.

The data processing system can receive a data stream from at least one of the plurality of edge devices. The data processing system can update the model based on the data stream. The data processing system can deploy the updated model to the plurality of edge devices for use by the application installed on the plurality of edge devices.

The data processing system can identify a group identifier linked with the plurality of edge devices. The data processing system can push an update to the plurality of edge devices linked with the group identifier.

The data processing system can determine, based on a computational load balancing policy, to install a second application on a subset of the plurality of edge devices. The data processing system can provide the second application on the subset of the plurality of edge devices.

The application can determine a distance to a fault responsive to detection of a power outage notification. The data processing system can receive the application from a third-party application developer device remote from the data processing system.

The data processing system can provide, via an interface, a list of a plurality of applications configured to execute on the plurality of edge devices. The plurality of applications can comprise: a first application configured to determine a distance to a fault responsive to detection of a power outage notification; a second application configured to detect an anomaly; a third application configured to detect electric vehicle charging; and a fourth application configured to determine a location of an edge device on the electricity distribution grid based on a fingerprint associated with characteristics of voltage at the location on the electricity distribution grid. The data processing system can receive a selection of the application from the list of the plurality of applications. The data processing system can provide the application for installation on the plurality of edge devices responsive to the selection.

The data processing system can provide a runtime environment on the data processing system to host a second application configured to interface with the application executed on the plurality of edge devices.

In another aspect, this disclosure is directed to a method for a smart grid distributed operations platform. The method can include identifying, by a data processing system comprising a processor coupled with memory, a network connection with a plurality of edge devices located on an electricity distribution grid, wherein each of the plurality of edge devices comprise a processor and memory. The method can include identifying, by the data processing system based on a configuration associated with the plurality of edge devices, an application configured to perform a function to manage delivery of electricity via the electricity distribution grid. The method can include selecting, by the data processing system, a model from a plurality of models trained with machine learning based on a local environment attribute associated with a location on the electricity distribution grid at which the plurality of edge devices are located. The method can include providing, by the data processing system for execution on the plurality of edge devices, the application configured with the model to perform the function to manage delivery of electricity via the electricity distribution grid.

The method can include determining, by the data processing system, a data security policy based on the configuration. The method can include setting, by the data processing system, the application with the data security policy, wherein the data security policy controls access to a type of data, a type of metric, or a type of function.

The method can include identifying, by the data processing system, a second application installed on the plurality of edge devices. The method can include providing, by the data processing system, an instruction to the application to cause the application to output data to the second application to perform one or more functions to manage delivery of electricity via the electricity distribution grid.

The method can include identifying, by the data processing system, a second application installed on the plurality of edge devices. The method can include updating, by the data processing system, a configuration of the second application based on output from the application.

The method can include receiving, by the data processing system, a data stream from at least one of the plurality of edge devices. The method can include updating, by the data processing system, the model based on the data stream. The method can include deploying, by the data processing system, the updated model to the plurality of edge devices for use by the application installed on the plurality of edge devices.

The method can include determining, by the data processing system based on a computational load balancing policy, to install a second application on a subset of the plurality of edge devices. The method can include providing, by the data processing system, the second application on the subset of the plurality of edge devices.

The method can include providing, by the data processing system via a graphical user interface, a list of a plurality of applications configured to execute on the plurality of edge devices. The plurality of applications can comprise: a first application configured to determine a distance to a fault responsive to detection of a power outage notification; a second application configured to detect an anomaly; a third application configured to detect electric vehicle charging; and a fourth application configured to determine a location of an edge device on the electricity distribution grid based on a fingerprint associated with characteristics of voltage at the location on the electricity distribution grid. The method can include receiving, by the data processing system, a selection of the application from the list of the plurality of applications. The method can include providing, by the data processing system, the application for installation on the plurality of edge devices responsive to the selection.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 is a block diagram illustrating an example system for a smart grid distributed operations platform, in accordance with an implementation;

FIG. 3 is a flow diagram of an example method for a smart grid distributed operations platform, in accordance with an implementation;

FIG. 4 is a flow diagram of another example method for a smart grid distributed operations platform, in accordance with an implementation; and

FIG. 5 is a block diagram illustrating an architecture for a computer system that can be employed to implement elements of the systems and methods described and illustrated herein, including, for example, aspects of the utility grid depicted in FIG. 1 or the system depicted in FIG. 2.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of a smart grid distributed operations platform (SGDOP). The various concepts introduced above and discussed in greater detail below may be implemented in any of numerous ways.

The systems and methods of the technical solution can include a smart grid distributed operations platform (SGDOP) to provide the capabilities of the grid edge intelligence (e.g., metering devices) and the distributed IoT computing platform for managing the load or adjusting the DER values for the utility grid. A grid edge can refer to a location on the utility grid at which energy is put to use, such as at near or at a customer site. For example, the edge can refer to the point on the grid at which customer devices are connected to the utility network and electricity reaches to the customer site. The grid edge portion of the network can be lower voltage relative to the primary distribution circuit. In some cases, the grid edge network can correspond to or refer to the secondary utilization circuits. Each metering device can capture or obtain data in relatively real-time. The metering device can include a graphic processing unit (GPU) configured to process collected data, thereby combining metrology and GPU processing capability to enable distributed edge computing or learning. The SGDOP can include the IoT (e.g., open-IoT) platform, enabling the deployment and management of software applications for the metering devices. For instance, the SGDOP can combine the capabilities for utility usage of IoT that leverages the metering device as the edge compute-surface (e.g., surface computer) and augment the metering device capabilities with GPU capabilities to enable distributed artificial intelligence (AI) for managing various components within the utility grid. Hence, the deployment of the SGDOP can improve at least load management and DER value adjustment for the decentralized, bidirectional, DER-integrated utility grid.

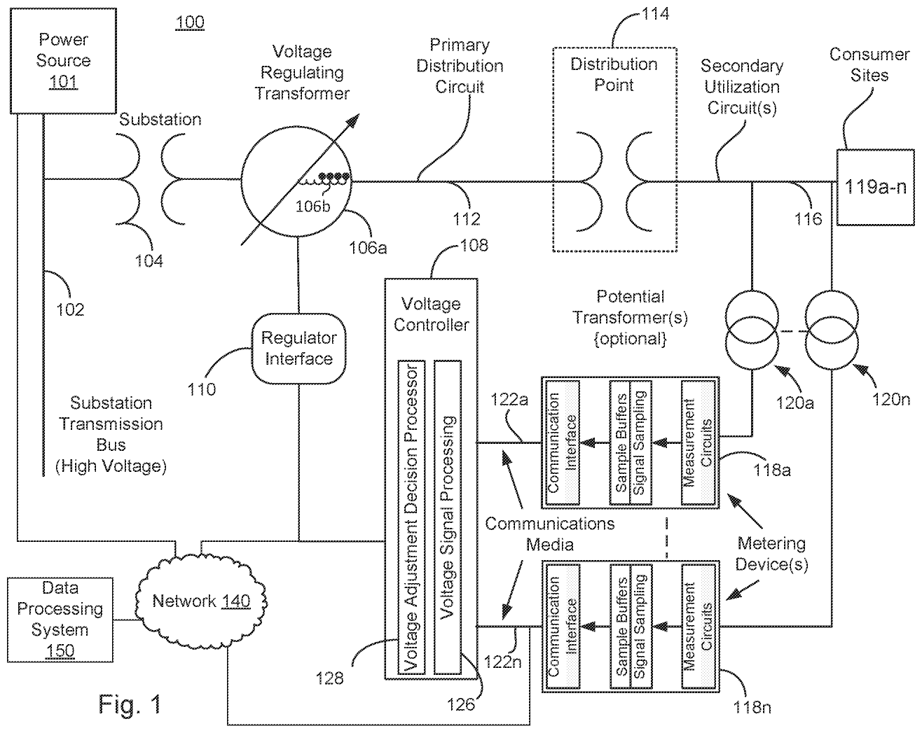

FIG. 1 depicts an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 and/or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 119 connected to circuit 112 or 116 from a power source 101 coupled to bus 102. These metering devices 118a-118n, among other components within utility distribution grids, can collect samples of power delivery or consumption, such as voltage information, at a predetermined sample rate. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

In FIG. 1, in further detail, the utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power plant 101 and the consumer electoral devices 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an alternating current (AC) power distribution system and the term voltage can refer to an “RMS Voltage”, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition/event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 140 can be any type and/or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 500 or a portion of computing device 500 or some or all functionality of computing device 500.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuitry (e.g., a central processing unit or CPU) that responses to and processes instructions fetched from a memory unit (e.g., memory 815 or storage device 825). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150.

The data processing system 150 can obtain measurements (e.g., raw or processed data or electric waveforms) from the one or more metering devices 118 within the utility grid 100. The data processing system 150 can receive or obtain the measurements from the metering devices 118 in response to each metering device 118 performing the measurement. The data processing system 150 may receive an aggregate of the measurements from the metering devices 118. In this case, each metering device 118 may store the measurements in a local memory and send the data in response to at least one of a predetermined time interval for a scheduled transmission, receiving a request for data from the data processing system 150, or a predetermined duration, size, or amount of data samples is collected. In some cases, the metering devices 118 can process the data prior to transmitting the data to the data processing system 150.

This technical solution can include a smart grid distributed operations platform (“SGDOP”) that can provide IoT and edge-computing capabilities to the electrical distribution grid (e.g., utility grid 100). The SGDOP can be implemented as part of the utility grid 100 or one or more components of the utility grid 100. In some cases, the SGDOP can include one or more components of the utility grid 100, such as the data processing system 150, among others, to provide one or more applications for edge devices. Herein, the term application (or software application) may refer to or include a set of instructions stored in a tangible medium, executable by at least one processor. The application can be configured or designed to perform predefined functions on a computing device, such as but not limited to the data processing system 150, the edge device 201, etc. The application can encompass executable code, which may interact with hardware components to achieve predefined tasks or processes. In some configurations, one or more non-limiting features of the SGDOP can be implemented as part of the data processing system 150 or other components of the utility grid 100. The SGDOP can provide the utility operators or edge device operators with at least one of, but not limited to, the following:
A relatively high-resolution, contextualized data or information to applications on or with-access-to the platform (e.g., SGDOP). The applications can be executed on the edge devices. The applications can be managed by the data processing system 150 or other components of the utility grid 100 for the edge devices, such as selecting, providing, or updating the applications for the edge devices.
·A compute surface configured with parallel processing capabilities, for example, to increase the performance or enhance the execution of machine learning (ML) or artificial intelligence (AI) operations in a local environment of an on-platform application. The on-platform application may be installed on the edge devices. The edge device can include or correspond to the metering device 118, client device, or other devices operated by the user (or client), for instance, at the consumer site 119.
A mechanism to transmit or receive (e.g., communicate) signals via the platform to the metering devices 118 (e.g., behind-the-meter (BTM) devices).

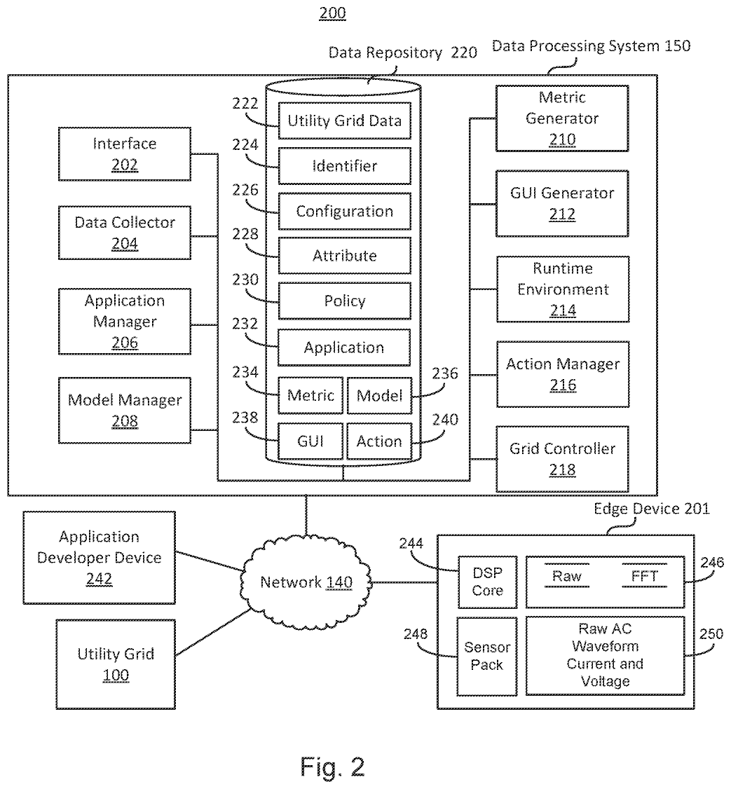

Given the aforementioned non-limiting capabilities, the SGDOP can allow (or enable) an ecosystem of load or generation entities to manage the respective electrical input or output to satisfy/meet a desired operator-defined electricity objective function (e.g., configuration, criteria, or parameters for distribution or consumption of electricity). For example, the SGDOP can allow (or enable) the ecosystem to incentivize the behavior of the load or generation entities to modify the respective electrical input/output according to the operator-defined objective for the utility grid 100. In another example, as described in conjunction with at least FIG. 2, the data processing system 150 can include one or more features of the SGDOP to execute actions or send commands to components of the utility grid 100 to control or manage electricity generated or provided to metering devices 118 or edge devices.

In various aspects, the SGDOP can combine or integrate multiple platforms (e.g., IoT platform and edge computing capabilities, among others) for enhancing the distribution of electricity for the decentralized, bidirectional, DER-integrated utility grid. The SGDOP can be deployed in conjunction with the metering device 118 in communication with an IoT cloud platform. The IoT cloud platform can include or be a part of the data processing system 150. For example, the metering device 118 can be in communication with the data processing system 150 (e.g., IoT cloud platform) via the network 140. In some cases, the metering device 118 can include a meter collar embedded with a runtime platform/environment. The meter collar can include at least a graphic processing unit (GPU) and metrology board configured to enable real-time data collection and distributed AI models for execution at the grid edge (e.g., executed on edge devices). The runtime platform can connect to the IoT cloud platform (e.g., the data processing system 150), for instance, using open protocols. The communication between the runtime platform and the IoT cloud platform can provide a mechanism for updates and deployment of applications and models to the edge devices, e.g., metering devices 118 or client devices. The runtime platform and the IoT cloud platform can be parts of the SGDOP. The runtime platform can be implemented with the IoT cloud platform to manage the applications for the edge devices, as part of the features of the SGDOP.

The SGDOP can include or provide one or more non-limiting capabilities. For example, the SGDOP can provide real-time access to grid information, third-party application deployment and management, or secure cloud data services and application programming interface (API). The real-time access to grid information can provide core services executing (or performing) physics and ML models on a GPU-enabled device (e.g., metering device 118 or other edge devices). The metering device 118 with GPU-enabled can provide streaming or real-time grid data to at least one of the applications executing locally on the metering device 118 or to the data processing system 150 (e.g., cloud or remote computing device, which may be hosting the application).

The third-party application deployment and management can provide centralized cloud deployment of new or updated containerized applications or models to the edge device. To capture localized differences in the grid (e.g., mesh vs. radial circuit), a trained ML model can be executed or utilized in the cloud (e.g., the data processing system 150 or remote devices) before the models are sent to the edge computing platform. The secure cloud data services and API can allow (or enable) utility or third-party network (e.g., web) data aggregations or analytics across the SGDOP, including data and intelligence sharing across different tenants (e.g., edge devices or metering devices 118).

FIG. 2 depicts a block diagram illustrating an example system 200 for a smart grid distributed operations platform. The system 200 can include, interface with, access, or otherwise communicate with at least one utility grid 100, at least one data processing system 150, at least one edge device 201, and at least one application developer device 242. The data processing system 150 can include one or more components (e.g., one or more processors, memory, databases, or interfaces) configured to perform features or functionalities discussed herein for managing applications for at least one edge device 201. The system 200 can correspond to, include, or be a part of the SGDOP. For example, the system 200 can include one or more features or functionalities of the SGDOP to provide IoT and edge-computing capabilities to the utility grid 100 (e.g., including the edge devices 201). The system 200 (e.g., SGDOP) can be deployed or implemented (in conjunction) with one or more edge devices 201 connected to a cloud platform (e.g., the data processing system 150 or other devices connected to the network 140) to provide various capabilities to the edge devices 201. The software services executing on the edge devices 201 and the data processing system 150 (or the cloud) can provide at least one of connectivity, IoT data and device management, cloud computing, or application development functionalities.

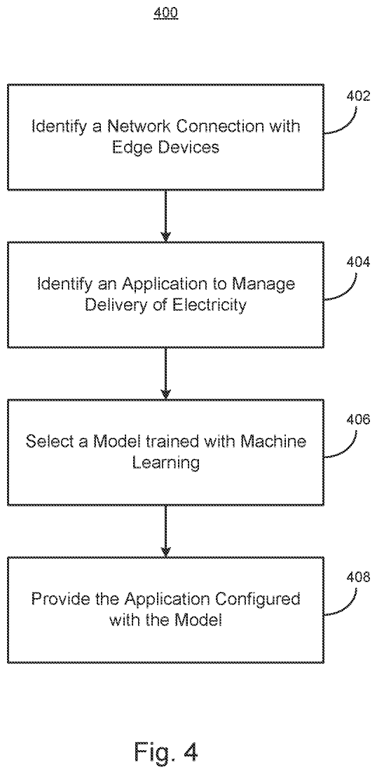

The logical architecture of the system 200 (or the data processing system 150) can include at least one of runtime environment, IoT connectivity, or a cloud data layer. The runtime environment layer (e.g., data structure) can provide data structures configured to extract characteristic information (e.g., behavior data) from the electrical waveforms measured at the grid edge, e.g., by the edge devices 201 or the metering devices 118. The electrical waveforms can correspond to at least one of the voltage or current waveforms. The data structures can include a set of core services and a common data bus (e.g., core bus). The IoT edge connectivity layer (e.g., data pipeline) can contextualize and communicate the relevant data to applications executing locally on the edge devices 201 or from the edge device 201 to the cloud (e.g., data processing system 150). The data pipeline can be described in further detail in conjunction with FIG. 4, for example. The cloud data layer can securely store the data obtained from the edge devices 201 in a data repository (e.g., as described in conjunction with the data repository 220 of FIG. 2). The data repository may be referred to as or used interchangeably with other descriptive terms, such as a database, data storage, or memory device. The cloud data layer can provide access to the stored data for authorized devices, such as the data processing system 150 or the edge device 201 (or metering device 118). The cloud data layer may be associated with or configured in the data processing system 150, for example.

As discussed herein, for instance, the capabilities provided by the system 200 can include but are not limited to, real-time access to grid information (e.g., at the edge device 201), third-party application deployment or management, or secure cloud data services and API. Such capabilities can involve one or more components in the system 200, not limited to the utility grid 100, the data processing system 150, edge device 201, or application developer device 242.

The edge device 201 can include or correspond to one or more metering devices 118 located in the utility grid 100. In this case, the edge device 201 can include a GPU or metrology board (e.g., a circuit or device configured to perform metrology. The edge device 201 can include support for or be compatible with ML or AI operations in real-time or in parallel processing. In this case, the edge device 201 may monitor electricity distributed to a load. The edge device 201 can include or be installed with applications or software components downloaded from the data processing system 150 or the application developer device 242, for example. The edge device 201 can include at least one digital signal processor (DSP) core 244 and at least one sensor pack 248 for capturing at least raw electrical data 250. The DSP core 244 can receive at least one of raw data or Fourier transformed data 246 from the sensor pack 248.

The sensor pack 248 can include one or more sensors configured to sense, measure, or obtain electrical data (e.g., time-series data) at the edge device 201, such as the raw electrical data 250 (e.g., voltage or current data). The DSP core 244 can involve, determine, or provide processed information associated with the raw data or Fourier transformed data 246, such as but not limited to the RMS of waveform data, amplitude of the waveform, the Fast-Fourier transform (FFT) spectrum, among other information, for example. The information from the DSP core 244 can be used by the data processing system 150 or other components of the runtime platform (or of the system 200) to perform the predefined features, not limited to anomaly detection, anomaly classification, digital fingerprint, etc.

In some cases, the edge device 201 can be a computing device local to or remote from the utility grid 100, such as a client device operated by a user of the metering device 118. For example, the edge device 201 can include at least one processor and a memory, e.g., a processing circuit. The edge device 201 can include various hardware or software components, or a combination of both hardware and software components. In this case, for example, the edge device 201 can include, but is not limited to, a television device, a mobile device, smart phone, personal computer, a laptop, a gaming device, a kiosk, or any other type of computing device accessible by the user.

In further examples, the edge device 201 can interface with the metering device 118 via wired or wireless connections. The edge device 201 can communicate with the metering device 118 via an application installed on the metering device 118. The edge device 201 may be installed with the application for communication with the metering device 118. The edge device 201 may access the application installed on the metering device 118 via other platforms, e.g., via a website. The edge device 201 can monitor electrical utilization or other grid information (e.g., in real-time) via the application, manage the application(s) installed on the metering device 118, or provide information to the user of the edge device 201 (e.g., via display device configured to display a graphical user interface (GUI), notification, or other types of interface). The edge device 201 may receive updated application data from the data processing system 150 or the application developer device 242. The edge device 201 may relay the updated application data to the metering device 118 to update the application. In some configurations, the updated application data can be received directly by the metering device 118. In some other cases, the edge device 201 can be a part of or perform one or more functionalities similar to the data processing system 150.

The application developer device 242 can be a computing device including one or more processors and memory operated by an application developer. The application developer device 242 can be remote from the utility grid 100. The application developer device 242 can communicate with other devices within the network 140, including but not limited to the data processing system 150, the edge device 201, etc. The application developer device 242 can be operated by the application developer to create, update, or otherwise manage one or more applications. The application developer device 242 may receive at least one application from other devices within the network 140, such as the data processing system 150 or the edge device 201. The application developer device 242 can include a database or memory configured to store data received, generated, or provided by the application developer device 242, such as data related to the application or similar data to those stored on the data processing system 150 or the edge device 201, for example.

In some configurations, the application developer device 242 may be one of the edge devices 201. For example, the application developer device 242 may be a client device operated or accessible by a user. The application developer device 242 may receive inputs from the user creating a set of machine-readable instructions as part of the application development, for example. The application developer device 242 can upload the application to the network 140, e.g., send the application data to the data processing system 150 for validation and deployment. In this case, the data processing system 150 may be an intermediary device configured to validate the application (e.g., ensure a desired operation of the application, prevent security risk, or perform other verification processes) and deploy the verified application to the edge devices 201. Certain applications may be deployed (e.g., downloaded by the edge devices 201) automatically or stored in the data repository 220 for edge devices 201 to download, for example, via an application store, marketplace, or website.

In some cases, the application developer device 242 can include one or more features or functionalities of the data processing system 150. For instance, the application developer device 242 can include one or more components of the data processing system 150 configured to manage applications for the edge devices 201, such as selecting, providing, or updating applications for the edge devices 201. The application developer device 242 may perform security checks, data verification, hardware or software compatibility confirmation, or perform a test or simulation using the application to ensure the desired operation of the application. The application developer device 242 may manage certain configurations for the edge devices 201, e.g., data security policy, monitoring tools, hardware or software compatibility, etc. By validating the software application, the application developer device 242 may allow the edge device 201 to download the application directly from the application developer device 242 or send the application data directly to the edge device 201. In certain situations, the application developer device 242 (or the data processing system 150) may prevent the edge device 201 from downloading applications that are incompatible with the edge device 201, e.g., hardware or software incompatibility.

The data processing system 150 can transmit or receive data to or from other components (e.g., utility grid 100, edge device 201, or application developer device 242) of the system 200 via the network 140. The utility grid 100 and the network 140 can be referred to in conjunction with FIG. 1. The one or more devices, components, or systems (e.g., edge device 201, or application developer device 242) of the utility grid 100 or the system 200 can be composed of hardware, software, or a combination of hardware and software components.

The data processing system 150 can include or correspond to at least one computing device or a cloud computing system remote from the edge devices 201, configured to manage applications or configurations for the edge devices 201. The data processing system 150 can be located within or outside the utility grid 100. The data processing system 150 can communicate to other devices within the network 140 via wired or wireless communication. The data processing system 150 can receive and process data locally on the utility grid 100. In some arrangements, the data processing system 150 can receive and process data remotely from the utility grid 100. There may be multiple computing devices within the system 200 configured to perform at least a portion of the features of the data processing system 150. In some cases, the data processing system 150 can forward or delegate one or more features or functionalities to another computing device local to or remote from the utility grid 100. For instance, the data processing system 150 can transmit data to a remote computing device executing in a cloud computing environment or distributed computing environment. The data processing system 150 may process a portion of the information and the remote computing device may process another portion of the information, as part of delegating processing tasks. For purposes of providing an example, the data processing system 150 may be a remote computing device or a cloud computing device configured to process data for managing applications or other data for the SGDOP.

In some arrangements, the data processing system 150 may include or be a part of the application developer device 242 configured to generate applications for the edge device 201. In some other arrangements, the data processing system 150 may include or be a part of the edge device 201 to receive (or install applications) to manage, in part, electricity distribution in the utility grid 100 or monitor grid information.

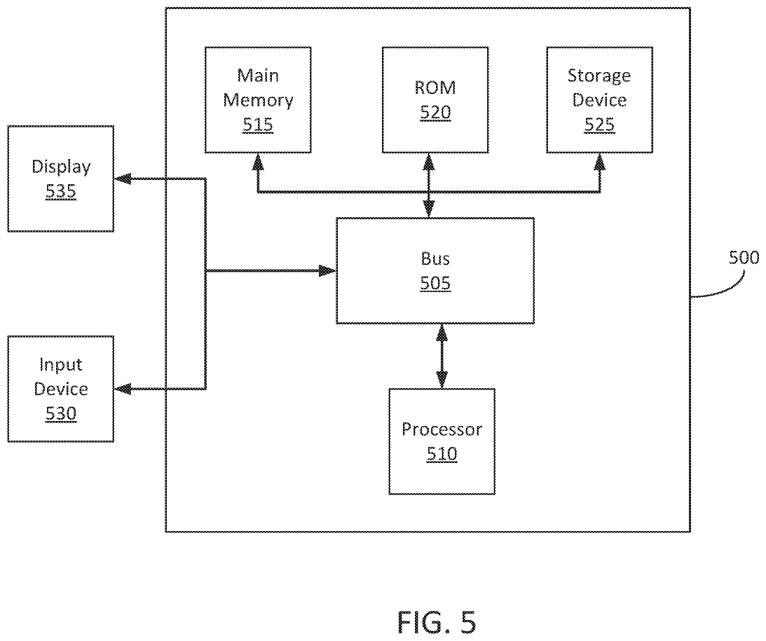

The data processing system 150 can include one or more components for managing applications for the edge devices 201, for instance, at least one interface 202, at least one data collector 204, at least one application manager 206, at least one model manager 208, at least one metric generator 210, at least one GUI generator 212, at least one runtime environment 214, at least one action manager 216, at least one grid controller 218, and at least one data repository 220. Each of the components (e.g., interface 202, data collector 204, application manager 206, model manager 208, metric generator 210, GUI generator 212, runtime environment 214, action manager 216, grid controller 218, or data repository 220) of the data processing system 150 can be implemented using hardware or a combination of software and hardware. Each component of the data processing system 150 can include logical circuitry (e.g., a central processing unit or CPU) that responds to and processes instructions fetched from a memory unit (e.g., memory 515 or storage device 525 of FIG. 5). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements (e.g., interface 202, data collector 204, application manager 206, model manager 208, metric generator 210, GUI generator 212, runtime environment 214, action manager 216, grid controller 218, or data repository 220) of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. In yet another example, the components of the data processing system 150 can be a single component to perform one or more features or functions discussed herein. The components of the data processing system 150 can be connected or communicatively coupled to one another, such as via the interface 202. The connection between the various components of the data processing system 150 can be wired or wireless, or any combination thereof. Counterpart systems or components can be hosted on other computing devices.

The interface 202 can interface with the network 140, devices within the system 200 (e.g., edge device 201, utility grid 100, or application developer device 242), or components of the data processing system 150. The interface 202 can include features and functionalities similar to the communication interface of one or more metering devices 118 to interface with the aforementioned components, such as in conjunction with FIG. 1. For example, the interface 202 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 202 can include at least a built-in network adapter, network interface card, PCMCIA network card, EXPRESSCARD network card, card bus network adapter, wireless network adapter, USB network adapter, modem, or any other device suitable for interfacing one or more devices within the system 200 to any type of network capable of communication. The interface 202 can communicate with one or more aforementioned components to receive data from at least one of the utility grid 100, the metering device 118, the edge device 201, or the application developer device 242. For example, the data processing system 150 can send or receive data to or from the devices within the network 140 to manage applications for the edge device 201.

The data collector 204 can obtain or collect data within the utility grid 100, including but not limited to data from the metering devices 118, the edge devices 201, or the application developer device 242. The data collector 204 can obtain the data via the interface 202. The data collector 204 can store the obtained data in the data repository 220. In some cases, the data collector 204 may store the obtained data in a remote storage device.

For example, the data collector 204 can obtain data from the metering device 118 including but not limited to electrical data of electricity distributed to or consumed by individual metering devices 118 within the utility grid 100. The electrical data can include data samples of an electrical waveform corresponding to electricity (e.g., electrical signals) distributed at or to one or more locations associated with individual metering devices 118 on the utility grid 100. For example, the data collector 204 can collect electrical data in residential areas (e.g., residential homes), such as to measure the electricity consumed or drawn at the consumer site 119. In another example, the data collector 204 can collect electrical data from the metering devices 118 located near or distributed for other areas or entities, such as commercial areas, industrial areas, facilities, or other areas with electrical distribution from the utility grid 100.

The electrical data can include electrical time-series data (e.g., voltage or current time-series) recorded at each metering device 118 over a time period. The data collector 204 can obtain a time-series data set recorded by a set of metering devices 118. The time-series data can represent a sequence of electrical data measured at successive points in time, such as voltage waveform data or current waveform data. In various cases, the data collector 204 can receive relatively high-resolution data, such as at least 1 kHz, 2 kHz, 3 kHz, 6 kHz, or 10 kHz of electrical data. In various cases, the electrical data discussed herein can be at least one of voltage data, current data, or power data, among other types of electrical information. The electrical data may include data processed by the metering device 118, such as filtered data, harmonic data, root-mean-square (RMS) value, compressed data, etc. The electrical data may be electrical waveform data (e.g., voltage waveform data or current waveform data) corresponding to electricity consumed by at least one load within the utility grid 100 and measured by at least one of the metering devices 118.

The data collector 204 can obtain data from the edge device 201 including but not limited to hardware or software data associated with the edge device 201, such as installed hardware components (for hardware support), software or firmware version, applications installed, configurations, time since last updated, data security policy, location of the edge device 201, device identifier, or other information related to the edge device 201. In some cases, the edge device 201 may correspond to one of the metering devices 118, such that the data collector 204 may obtain similar types of data from the edge device 201 as the metering device 118 or vice versa. In some other cases, the edge device 201 may be a client device operated by the user, different from the metering device 118, where the edge device 201 can be in communication with the metering device 118. The data collector 204 can obtain data from the application developer device 242 including but not limited to application data for at least one application (e.g., new application) generated on the application developer device 242, update data for an existing application, or other application-related data.

The data collector 204 can obtain network connection data. The network connection data can include at least one of but is not limited to source and destination endpoints or addresses, communication protocols, timestamps, data payload, quality of service metrics, or security measures. The network connection data can be used by the one or more components of the data processing system 150 to identify network connections with the edge devices 201 within the network 140. The one or more components of the data processing system 150 can monitor, communicate, or otherwise manage the devices with the network connection to the data processing system 150. In some cases, the data processing system 150 can host applications for those connected edge devices 201, for example.

The application manager 206 can manage applications for devices within the network 140, such as the edge device 201 and the application developer device 242. The application manager 206 can manage the applications, for instance, by hosting the application for access to the edge device 201, where the edge device 201 can access the application by establishing a session with the data processing system 150, sending the application to the edge device 201 in response to a (e.g., download) request, updating the application, creating the application, etc.

The application manager 206 may receive application data uploaded or input by the administrator operating the data processing system 150. The application data can include machine-executable code or scripts as part of an application. The application manager 206 can compile the application data to deploy the application for download or installation by the edge devices 201 (or the application developer device 242, in some cases). The application manager 206 may perform at least one suitable validation technique or testing procedure to validate the application data, ensuring the desired or proper operations of the application. The validation technique may encompass a range of procedures, including but not limited to, functional testing, compatibility checks, or performance evaluations to verify the integrity and reliability of the application data for compilation and deployment. According to the validation results, the application manager 206 may prevent the deployment of the application or notify the administrator of the potential error. In response to validating the application, the application manager 206 can deploy the application.

Deploying the application can involve transferring the application to operational environments (e.g., runtime environment) connected to the IoT cloud platform using open protocols and the edge devices 201. The IoT cloud platform can include or be a part of the data processing system 150. Deploying the application can involve configuring the application to interact seamlessly with edge devices 201, initializing necessary parameters, or activating the application to commence its designated or configured functionalities. In some configurations, the deployment process can involve modifying or enhancing the application to ensure compatibility with one or more edge devices 201. In some cases, the application manager 206 can confirm whether the edge device 201 supports or is compatible with the application based on the application data and the edge device information. The application manager 206 may prevent the edge device 201 from installing the application in response to an incompatibility. The application manager 206 may modify the application to be compatible with the edge device 201. The application manager 206 may send a notification to the administrator (e.g., via a display device) or the edge device 201 indicating that the application is incompatible with the edge device 201. The application manager 206 can provide compatibility details regarding the application and the edge device 201 to the administrator or the user of the edge device 201, such as hardware support, software support, potential version disparity, or other relevant examples. The deployment and features (or types) of the application or the interface between the data processing system 150 and the edge device 201 for application deployment can be described in the non-limiting examples herein.

The application manager 206 can receive the application from the application developer device 242 (e.g., a third-party application developer) remote from the data processing system 150. For example, the application can be created by an application developer operating the application developer device 242. The application can be stored on the application developer device 242. To deploy the application for utilization by the edge devices 201, the application developer device 242 can upload the application to the data processing system 150. The application manager 206 can receive the uploaded application from the application developer device 242. The application manager 206 can perform a validation process to determine whether to deploy the application. The application manager 206 can store the application in the data repository 220. In some cases, if the application fails the validation process, the application manager 206 may not store the application. In some arrangements, the application may be hosted by the application developer device 242 or the data processing system 150, for example.

In some configurations, the application manager 206 can identify or select at least one application to provide to the edge device 201. The application manager 206 can identify the application according to a configuration associated with the edge device 201. The configuration associated with the edge device 201 can indicate one or more parameters, settings, or functionalities configured for (or to be installed on) the edge device 201. The configurations associated with the edge device 201 may indicate the hardware component, software component, or a combination of hardware and software components included on the edge device 201. The configuration may include at least one of but not limited to resource availability (e.g., pre-configured on the edge device 201), connectivity (e.g., communication latency, stability, or other information with other network devices, including the data processing system 150 or other edge devices 201), operational state, environmental condition (e.g., weather data), device identity, performance data, energy management, compatibility and interoperability, or predefined settings (e.g., predetermined model for certain weather conditions, such as clear-sky model based on a solar irradiance) configured for the edge device 201. The configuration may indicate other information related to the edge device 201.

For example, the application manager 206 can determine one or more functionalities or features to be performed by an application according to the configuration (e.g., the predefined settings or selected functionalities). The functionalities may include at least one of but not limited to electricity distribution management, electricity monitoring tools, anomaly management, resolution service notifier, electric vehicle (EV) disaggregation, load forecasting, etc. The application manager 206 can identify a first subset of application(s) from a plurality of applications with the specified functions. For purposes of providing examples, the desired or predefined function for the edge device 201 can be for managing the delivery of electricity via the utility grid 100, although the application manager 206 can similarly identify the application(s) for other types of functions.

In further examples, the application manager 206 can identify or select a second subset of application(s) from the first subset of application(s) that satisfy the one or more parameters or criteria according to the configurations associated with the edge device 201. For example, the application manager 206 can identify the application that satisfies at least one of compatibility with the hardware or software components of the edge device 201, data security policy, pre-selected application developer, inclusion of certain language settings, inclusion of certain interfaces, or other predefined filters according to the configuration. In some cases, the application manager 206 may modify one or more applications to satisfy the configurations associated with the edge device 201. Subsequently, the application manager 206 can generate the second subset of application(s) configured to perform the function and satisfy the one or more parameters according to the configuration.

In some cases, the application manager 206 may select one application from the second subset to proceed to the subsequent process discussed herein. The application manager 206 may select the application from the second subset according to the rating (or review) of the application, administrator recommendation, geographical location of the edge device 201, or other selection criteria. The application manager 206 may provide the edge device 201 with the second subset for user selection. In some other cases, the application manager 206 may proceed to the subsequent process discussed herein (e.g., model selection and application) with multiple applications of the second subset, e.g., for the user to select at least one of the applications after configuring the applications with a model.

In some cases, there may be no application that satisfies the configuration associated with the edge device 201. For example, according to the configuration, the edge device 201 may lack compatibility, the specified function(s) may not exist in any application, there may not be a specified application developer, or there may not be an application satisfying the predefined user settings. In this case, the application manager 206 can send an indication to the edge device 201 indicating that no application is identified or found. The indication can be presented via a display device of the edge device 201. The configurations of the edge device 201 may be modified by the user. The application manager 206 may perform another iteration to potentially identify an application for the edge device 201 in response to the modification.

In various aspects, the application manager 206 can identify one or more applications to perform other functions for the edge device 201 according to the configuration associated with the edge device 201. For example, the application manager 206 can identify an application to perform the function of determining a distance to a fault responsive to the detection of a power outage notification, detect an anomaly, detect an anomaly, or determine the location of the edge device 201 on the electricity distribution grid (e.g., the utility grid 100) based on a fingerprint associated with characteristics of voltage at the location on the electricity distribution grid, to name a few. The application manager 206 can identify at least one application for other edge devices 201 according to their respective configurations.

For purposes of providing examples, the application manager 206 can identify one application from the plurality of applications that satisfy the configurations of the edge device 201. However, it should be noted that the application manager 206 can identify more than one application according to the configuration, and subsequent operations can be performed similarly as discussed herein.

The application manager 206 may determine a data security policy based on the configuration associated with the edge device 201. The data security policy can be configured by the user of the edge device 201 or set by the data processing system 150 as a part of a default setting. The data security policy can indicate information utilized by the application executing on the edge device 201 that may be accessed by other components via the network 140, such as the data processing system 150 or the application developer device 242. For example, the data security policy can control access to a type of data, a type of metric, or a type of function. The application manager 206 can set the application identified according to the configuration of the edge device 201 with the data security policy, such that the data security policy can control the access to information from the edge device 201 executing the application. For instance, upon executing the application configured or set with the data security policy, the application can filter data transmitted to the data processing system 150, the application developer device 242, or other devices within the network 140 using the data security policy, such that access to certain information are prevented for other devices within the network 140. In another example, the data security policy may indicate one or more devices within the network 140 that are allowed to access certain types of information from the application.

The application manager 206 can store the application data in the data repository 220. In some cases, the application manager 206 may store the application data on other devices within the network 140. The application manager 206 may update the application data in response to receiving updated data from the application developer device 242 or the administrator. The application manager 206 may perform routine maintenance (e.g., weekly or monthly) of the application data to ensure proper operation of the application.

In response to selecting the application, the application manager 206 may provide the application for execution on the edge device 201 (or one or more other edge devices 201). In some cases, the application manager 206 may provide the application configured with a model (e.g., managed by the model manager 208) to perform (or facilitate performing) the function of the application. For instance, as discussed herein, the application manager 206 can provide the application with the model to perform the function to manage the delivery of electricity to various locations or regions via the utility grid 100.

The model manager 208 can generate, train, or otherwise manage at least one model for execution on the edge device 201. The model may be referred to as a machine learning model or an artificial intelligence (AI) model. The model can be executed on the edge device 201 as part of the application. In some configurations, the model may be executed on the edge device 201 independent of the application. The model manager 208 can generate or train the model using at least one suitable machine learning technique. The machine learning technique can include but is not limited to supervised learning, unsupervised learning, reinforcement learning, transfer learning, etc. The model can include or correspond to a convolutional neural network (CNN) model, long-short-term-memory (LSTM) model, support vector machine (SVM), or other types of models. In some cases, the model manager 208 may use a combination of different types of models. The model manager 208 can receive training data for training the model. The model manager 208 may receive a model generated or trained by other devices within the network 140.

The model manager 208 can store the models in the data repository 220. The model manager 208 can manage a plurality of models. Each model may be configured to perform a certain feature, such as at least one of but not limited to detection of localized differences in the utility grid 100, electricity demand prediction, electrical pattern recognition, etc. The model manager 208 may update the model based on data (e.g., data stream) during the deployment of the model. The model may be used by the application during the model deployment.

The model manager 208 can select a model from the plurality of models trained with machine learning. The model manager 208 can select the model based on a local environment attribute associated with the location of the edge device 201 (or other edge devices 201) on the utility grid 100. The local environment attribute can refer to a characteristic or feature associated with a particular location on the utility grid 100, e.g., the location associated with the edge device 201 (or the metering device 118). This local environment attribute can include one or more factors such as weather conditions, power demand patterns, voltage levels, grid congestion, or any other relevant parameter that characterizes the environment at the location associated with the edge device 201. In some cases, the model manager 208 may select the model based on centralized variables or objectives, such as for electrical load balancing, grid stability, electrical distribution efficiency, etc. In some other cases, the model manager 208 may receive an indication to select at least one predetermined model, such as an indication from the administrator or utility operator. The model manager 208 can provide the model with the provided application. The model manager 208 may configure the application (e.g., from the application manager 206) with the model, such that the model executes and operates as part of the application.

For example, each model may be trained to operate within a predefined local environment attribute involving predefined voltage levels, grid congestion, locations within the utility grid, etc. The model manager 208 may select the model from a plurality of models based on the local environment attribute associated with the location of the edge device 201 on the utility grid 100. The selected model can be deployed or utilized by the application at the edge device 201. The model can perform pre-configured functions to facilitate the application. In some cases, the application can perform the feature according to the output from the model. The model can collect data during its execution with the application. The model can use the collected data (operated in the local environment attribute associated with the edge device location) to perform training procedures, thereby improving the performance of the model.

In further examples, the model may include but is not limited to a load forecasting model configured to predict or forecast electrical load at various edge devices 201 according to historical electrical demand or delivery information, weather conditions, etc. The load forecast can allow for an improved dispatch accuracy of available DERs at various locations associated with the edge devices 201, thereby for instance achieving an increase electrical distribution efficiency (e.g., as part of the electricity distribution objectives). In this case, the application (e.g., the DER dispatch application) can utilize a load forecasting model.

Using the application to manage the delivery of electricity as an example, the model can perform a prediction of changes in electrical demands at the metering device 118 associated with the edge device 201 over time. According to the output from the model, the application may manage the delivery of electricity by sending signals to one or more components of the utility grid 100 to adjust the electricity generation or distribution to the metering device 118 according to the changes in the electrical demands, for example.

The model can be configured to perform other features to facilitate the function of the application. For example, the application manager 206 can select an application performing the function of anomaly management, including at least one of anomaly detection or anomaly classification according to the configuration of the edge device 201. The model manager 208 can select a model from the plurality of models trained with machine learning based on the local environment attribute associated with the edge device location or according to other attributes. The model manager 208 (or the application manager 206) can configure the application with the model to perform the predefined function (e.g., anomaly management). In this case, the model can analyze the fingerprint or characteristics of the electricity, perform pattern recognition, etc., to predict or detect at least one anomaly for at least one metering device 118. The model can classify the anomaly according to the electricity characteristics, for example. The application configured with the model can present the predicted anomaly (or detect anomaly) to the user via the edge device 201, such as the display device of the edge device 201.

In some configurations, the model manager 208 can select a model for an application configured to perform the respective function, such as a first model for an application detecting EV charging, a second model for an application determining the location of the edge device (e.g., metering device 118) on the utility grid 100, a third model for determining the distance to a fault from the edge device 201 responsive to the detection of a power outage notification, etc. In this case, the model selected for the respective application can perform the respective functionalities, such as but not limited to fingerprint analysis associated with voltage characteristics, event prediction or detection (e.g., load forecasting, fault prediction, anomaly detection, or EV charging detection), etc.

In some cases, the model manager 208 may generate or train various models to configure for various functions of one or more applications. Each application may include one or more functions. For applications with more than one predefined type of function, the model manager 208 can configure multiple models for the application. For example, the model manager 208 can configure a first model for a first application with a first function. The model manager 208 can configure a second model and a third model for a second application with a second function and a third function. In some cases, the model manager 208 may configure one model for the application regardless of the number of functions to be performed by the application.

The model manager 208 may select the model based on other factors or conditions, not limited to the local environment attribute. For instance, the model manager 208 may select the model according to the application selected for the edge device 201, the type of function configured for the application, or compatibility with the edge device 201, to provide some examples. In some instances, the model manager 208 may select the model based on user-defined preferences. For instance, the model manager 208 may provide a list of models to the edge device 201. The list of models can include information associated with each model, such as version, update date, features or functionalities, training engine used for the model, etc.

The application manager 206 (or the model manager 208) can provide the application configured with the model to the edge device 201 for execution. In some cases, the application manager 206 can receive a request to download at least one application from the edge device 201 according to the configuration. The application manager 206 can provide a list of applications to the edge device 201 for selection by the user. The list may include pairs of applications and models. The same application can be paired with different models for selection. The application manager 206 can provide the application to the edge device 201 responsive to a selection. In some cases, the application manager 206 may automatically provide (or push) at least one application for installation on the edge device 201. The application may be selected by the administrator of the data processing system 150.

In some configurations, the model may be trained with data stream received from the edge device 201 (e.g., the metering device 118). For example, the data processing system 150 (e.g., data collector 204) can receive a data stream from the edge device 201 or other edge devices 201 within the network 140. The data stream can include electrical data monitored by the edge device 201, such as electrical waveform data, RMS values, harmonics, or other types of data monitored over time. The model manager 208 can update the model based on the data stream. For instance, responsive to receiving the new data stream, the application manager 206 can utilize the model to analyze the characteristics, trends, or patterns associated with the data stream. The data stream may provide an indication of detected faults, anomalies, or outages, among other events. In such cases, the model manager 208 can correlate the data stream to one or more events, such that the model can be updated to perform prediction or detection of certain events. The model manager 208 (or the application manager 206) can deploy the updated model to one or more edge devices 201 for use by the application installed on the edge devices 201.

The application manager 206 (or the model manager 208) may detect an outdated model of an application installed on the edge device 201. The model manager 208 can send update data to the edge device 201 for updating the model. In some cases, the model manager 208 may send a new (pre-trained) model to the edge device 201 for use by the installed application. In some arrangements, the model manager 208 may update the model for the application periodically or in response to a request to update the model received from the edge device 201. In some cases, the model manager 208 can push an update to various edge devices 201 to install or update the model for at least one application in response to a command from the administrator, e.g., broadcast the update to the edge devices 201. The model manager 208 may perform other operations not limited to those discussed herein to manage the model for the edge device 201 to be used by the application to perform the specified function. Similarly, the application manager 206 may perform other operations not limited to those discussed herein to manage the application for the edge device 201.

The metric generator 210 can determine, generate, or otherwise compute one or more metrics associated with the electricity delivered over the utility grid 100 over time. For example, the metric generator 210 can determine the one or more metrics based on or according to the voltage and current detected by the edge device 201, the sensor of the edge device 201, or the metering device 118. The metric can be represented as values, a table, or a data structure, among other forms computed from the monitored data (e.g., the data stream of the electricity delivered over the utility grid 100). For instance, the metrics can include at least one of a voltage harmonic metric, a current harmonic metric, a power metric, or other types of metrics not limited to those discussed herein. The metric generator 210 may generate the metric using the data stream. The metric may be referred to as an electricity utilization metric.

To generate the metric, the metric generator 210 can process the electrical information (e.g., raw electrical data as part of the data stream) received from the edge device 201 over a time interval. For example, the metric generator 210 can generate the electrical harmonic metric, energy consumption metric, power quality metric, electricity demand metric, power factor metric, voltage drop metric, power distribution metric, power outage metric, fault analysis metric, etc., by analyzing the data stream captured over time. For instance, the electrical harmonic metric may be generated by analyzing the amplitude or frequency of harmonics using Fourier transform. The energy consumption metric can be generated by aggregating the power (e.g., obtained from the data stream) measured over time. The power quality metric can be generated by analyzing the voltage and current waveforms using Fourier analysis, RMS phase angle, or other techniques. The electricity demand metric can be generated by monitoring the power levels over time. The other metrics can be generated by using other analytical techniques on the data stream.

In various configurations, the metric generator 210 can provide the metric to the model manager 208 as part of training the model. In some aspects, the metric generator 210 can provide the metric to the edge device 201, such that the application utilizing the model can perform its function, such as managing the delivery of electricity. In this case, the data processing system 150 can provide the computational power for the edge device 201. In some other cases, the edge device 201 can generate the metric responsive to receiving the data stream. The metric generator 210 can store the metric in the data repository 220.

The GUI generator 212 can generate, update, or otherwise manage an interface or GUI for the data processing system 150, the edge device 201, or other devices within the network 140. The GUI can include graphical elements for presentation to operators of respective devices via a display device (e.g., a display 535, described in conjunction with FIG. 5). The GUI generator 212 can generate any type of interface to present information to the operator, not limited to texts, icons, interactive elements, or visual graphics. For example, the GUI generator 212 can generate a map including the locations of the metering devices 118 (or edge devices 201). The GUI generator 212 can generate notifications, pop-up windows, or alerts based on detected events, including outages, detected faults, or maintenance being conducted in the utility grid 100, for example.

The GUI generator 212 can generate the GUI for each application. The GUI of the application can be pre-programmed by the application developer, for example. The GUI can be specific to the respective application. The GUI generator 212 can generate different GUI elements depending on the function of the application. For example, for the application managing the delivery of electricity, the GUI generator 212 can generate an interactive chart displaying real-time energy consumption at various edge devices 201, interactive elements for controlling the energy distribution parameters, or a visual representation of an electricity grid topology, as part of the GUI.

In another example, for the application providing a distance to the fault, the GUI generator 212 can generate a power outage notification received from one or more components of the utility grid 100 or from other applications associated with other edge devices 201. Subsequent or concurrent to the notification, the GUI generator 212 can display a visual representation of a map or topology of the utility grid 100 including the determined location of the fault that causes the power outage. In some cases, the map may include an indication (e.g., text or visual element) of the distance, direction, or location of the fault with respect to the location of the edge device 201 executing the application. Other types of GUI elements can be generated not limited to those herein, and can be based on at least the type of application, the function of the application, the configuration of the edge device 201, or the configuration set by the administrator.

In some cases, the GUI generator 212 can present or provide a list of applications configured to execute on one or more edge devices 201 via an interface. The interface may be a GUI presentable via a display device. The interface may be an API providing a set of protocols or tools for interaction between devices or components, such as between the data processing system 150 and the edge device 201 or between the GUI generator 212 can the display device (not shown). The GUI generator 212 can provide the list via the interface of the data processing system 150 for selection by the administrator. The GUI generator 212 may provide the list via the interface of the respective edge devices 201 for user selection to install at least one of the applications.

For example, the GUI generator 212 can provide a list including a first application, a second application, a third application, and a fourth application. These applications can be configured to perform different functionalities. For instance, the first application can be configured to determine a distance to a fault responsive to the detection of a power outage notification. The second application can be configured to detect an anomaly. The third application can be configured to detect electric vehicle charging. The fourth application can be configured to determine the location of the edge device 201 on the electricity distribution grid based on a fingerprint associated with characteristics of voltage at the location on the electricity distribution grid. In some configurations, certain applications provided in the list may provide similar functionalities. The list can include interactive elements for selecting application(s) from the list. The GUI generator 212 can receive an indication of a selection (e.g., by the administrator or the user) of the application from the list of applications. Responsive to the selection, the data processing system 150 (e.g., application manager 206) can provide the application for installation on the one or more edge devices 201.

The runtime environment 214 can provide a runtime environment on the data processing system 150 to host one or more applications configured to interface with the application executed or installed on the edge devices 201 within the system 200 (e.g., SGDOP). As part of the SGDOP architecture, for example, the runtime environment 214 can provide a runtime environment serving as an ecosystem that accommodates various applications to optimize grid operations, allow edge devices 201 to install applications from third-party application developers, or facilitate collaborative functionalities between edge devices 201 and the data processing system 150.

For example, the runtime environment 214 can host applications (e.g., a second application) that allow real-time monitoring of grid information, leveraging the SGDOP real-time access capabilities. The second application hosted by the runtime environment 214 can interface with the application executed on the edge device 201 to provide the grid information or other types of information. The runtime environment 214 can support the deployment or management of applications from third-party application developers. The runtime environment 214 can provide a secure and centralized deployment of new or updated containerized applications to the edge devices 201.

In various configurations, the runtime environment 214 can facilitate collaborative functionalities between the plurality of applications on the SGDOP, such as facilitating the communication or sharing of information between applications from the application developer device 242 (or other third-party application developers), preinstalled applications on the edge devices 201, etc. The applications may be executed independently on edge devices 201 or simultaneously between multiple edge devices 201. The runtime environment 214 can allow for data pathways such that applications can share or communicate data with each other. The data pathway, given the permissions or security criteria between the applications, can allow for the collaborative functionalities.

The runtime environment 214 may provide an integration of (e.g., machine learning) models and analytics applications, providing a versatile platform for addressing localized differences in the utility grid 100. The runtime environment 214 can leverage open protocols to allow for efficient data exchange and the deployment of new functionalities and models from the data processing system 150 to the edge devices 201 (or between edge devices 201). For purposes of providing examples, the runtime environment 214 can provide an interface between the data processing system 150 and the edge devices 201 or between the application(s) hosted on the data processing system 150 and the application(s) executed on the edge devices 201.

The action manager 216 can select or manage actions to be performed by the data processing system 150, such as executing or initiating an action of one or more components of the data processing system 150 as described in the non-limiting examples herein. In some cases, the action manager 216 can manage actions to be performed on the utility grid 100, such as sending information or instructions to components or devices in the utility grid 100. The action may include but is not limited to providing applications to edge devices 201, configuring the application with the model, sending updates to the edge devices 201, sending instructions to one or more components within the utility grid 100 for managing the delivery of electricity, sending notifications to the edge devices 201, pushing applications for installation on one or more edge devices 201, etc.

For example, the action manager 216 may identify a group identifier linked with a plurality of edge devices 201 or a subset of edge devices 201 in the utility grid 100. The edge devices 201 associated with the group identifier may include at least one common feature, such as receiving electricity from the same transformer (e.g., secondary transformer), located proximal to each other, having similar configurations, or having an outdated application or configuration, among other grouping parameters. Based on the identified group identifier and the associated subset of edge devices 201, the action manager 216 can push an update to the subset of edge devices 201 linked with the group identifier, such as to update the application, configuration, or to perform a certain function desired by the data processing system 150 or the utility grid operator.

In another example, the action manager 216 can send instructions to the edge devices 201 to execute the application. For instance, the action manager 216 may send the instructions to execute the application of the edge devices 201 during a power outage, where the application can be configured to determine a distance from the respective edge device 201 to the fault. In this case, responsive to the application (or the edge device 201) detecting a power outage notification, the application of the edge devices 201 can determine the distance to the fault and report the distance to the data processing system 150 or to the utility operator device.

In some cases, the action manager 216 may identify an existing application (e.g., a second application) installed on the edge device 201. For purposes of providing examples, the second application can be configured to perform a function of managing the delivery of electricity via the utility grid 100, similar to the identified application, although other functions can be configured for the second application. The second application can be configured to adjust the electricity distribution parameters of one or more components within the utility grid, and the (e.g., first) application can be configured to monitor the electricity at the edge device 201 (or other edge devices 201) as part of managing the delivery of electricity. In this case, for example, the action manager 216 can provide an instruction to the first application to cause the application to output data (e.g., monitored data) to the second application. Responsive to receiving the output data, the second application can perform one or more functions to manage delivery of electricity via the electricity distribution grid, such as increasing or decreasing electricity generation demand according to the monitored data, using the model configured for at least one of the first application or the second application.

The action manager 216 can send an update for updating the configuration of an application (e.g., a second application) according to the output from another application (e.g., the first application). To update the configuration of the second application, the data processing system 150 can receive information (e.g., power outage detection, location of the power outage, or electrical characteristics associated with the power outage) from the first application as an output to provide to the second application. Responsive to receiving the output, the data processing system can update the configuration of the second application according to the output from the first application. Updating the configuration can include changing parameters for managing the delivery of electricity for the utility grid 100 or updating information to be displayed via the second application, for example. For example, the application manager 206 (or the data collector 204) can receive outputs from the application provided to or installed on the edge device 201 in response to a power outage (e.g., indicated by a power outage notification). The output can include an indication of power outage detection, at least one location of the power outage, or electrical characteristics associated with the power outage. The action manager 216 can utilize the output from the first application to update the configuration of the second application (e.g., installed on the edge device 201) to adjust the delivery of electricity to the edge device 201 or balance the electrical load distributed in the utility grid 100, for example. In some cases, the second application may be provided to or installed on another edge device 201 or a utility operator device. In this case, the action manager 216 can update the configuration of the second application to display the information related to the detected power outage or a location of the outage to the operator of the utility operator device.

In some cases, a load balancing policy may be implemented or configured by the administrator or according to the capability of the edge devices 201. The load balancing policy can be a computational load balancing policy for balancing the distribution of computational resources between edge devices 201 or one or more applications of at least one edge device 201. For example, the data processing system 150 can be configured with the (computational) load balancing policy. The load balancing policy can indicate the maximum computation resources (e.g., random-access memory to be allocated) capable of being handled by the edge device 201 or multiple edge devices 201. In some cases, the load balancing policy can be determined by the software or hardware capability or compatibility of the edge devices 201. Based on the load balancing policy, the action manager 216 may determine to install a second application on at least a subset of edge devices 201. The second application may be configured to receive delegated resources from at least one other application (e.g., the application installed on the edge device 201), such that the computational load can be reduced from the application. The action manager 216 can provide the second application on the subset of edge devices 201 for installation. With the second application installed, the edge device 201 may perform peer-to-peer communication or relay information via the data processing system 150 to at least one other edge device 201 installed with the second application to facilitate processing information received by the application. In such cases, the computational load can be balanced between multiple edge devices 201 (or reduced from at least one edge device 201).

In some configurations, each application installed on the edge device 201 may be allocated with predetermined computational resources, e.g., a predefined memory size, processing cores, GPU memory, or network bandwidth, among others. In such configurations, each application may have a predetermined computation threshold. According to the load balancing policy, the action manager 216 can facilitate balancing computational resources across different applications (of the same edge device 201 or between different edge devices 201), such that the computational resource is within the predetermined computation threshold, for example.

In some cases, the load balancing policy may be an electrical load balancing policy, including at least one strategy to balance the electricity distributed to different parts of the utility grid 100, such as geographical load balancing, load balancing according to electricity demand (e.g., which may depend on the time or environmental factor), round robin, etc. Based on the load balancing policy, the application manager 206 may determine to install an application (e.g., a second application) on a subset of the edge devices 201 to satisfy the load balancing policy. The application may be configured to manage the delivery of electricity to the subset of edge devices 201 according to the load balancing policy. For instance, the second application may be configured to manage the delivery of electricity for the subset of edge devices 201 differently from the first application of the edge device 201. In response to the determination, the action manager 216 may provide the second application for installation on the subset of the edge devices 201.

In some cases, the action manager 216 can send a notification or a prompt to the edge device 201 to confirm whether to install the application. In some cases, the action manager 216 can send the application to the edge devices 201 to automatically install the application. In some configurations, the action manager 216 can filter data from the application executing on the edge devices 201 according to the data security policy. The action manager 216 can perform other actions not limited to those discussed herein, such as predetermined actions stored in the data repository 220.

The grid controller 218 may perform at least one action selected or determined by the action manager 216 related to the utility grid 100. The grid controller 218 can perform the action for components or devices within the utility grid 100. For example, the parameters or configurations of the application may be adjusted as part of managing the delivery of electricity. The parameter can include at least one of voltage level, power factor, power quality, harmonics, load balancing, etc. The data processing system 150 may receive an indication that at least one parameter is adjusted on the application executed on the edge device 201. The indication may be received by an application hosted on the data processing system 150, for example. Responsive to the parameter adjustment, the grid controller 218 can adjust the parameters associated with one or more components in the utility grid 100, such as adjusting electricity generation to satisfy the electrical demand, electricity allocation to different locations for load balancing, etc. The grid controller 218 can perform other operations not limited to those discussed herein to control one or more components within the utility grid 100.

The data repository 220 can include, store, or maintain information or data collected, measured, obtained, or otherwise received as discussed herein. The data repository 220 may be referred to as a data storage, database, memory device, etc. The data repository 220 can include at least a utility grid data storage 222, an identifier storage 224, a configuration storage 226, an attribute storage 228, a policy storage 230, an application storage 232, a metric storage 234, a model storage 236, a GUI storage 238, and an action storage 240. The data repository 220 can include other types of storage to store information for components of the data processing system 150, the edge devices 201, or the application developer device 242. In some cases, information stored in the data repository 220 can be uploaded to or synced with an external database or other cloud storage devices. Certain types of information may be shared with other devices in the network 140. Certain types of information may not be shared with other devices in the network 140.

The utility grid data storage 222 can include, store, or maintain information related to the utility grid 100 obtained, measured, or detected by the edge device 201 or collected by the data processing system 150 (e.g., interface 202 or data collector 204). For example, the utility grid data storage 222 can store electrical data received or measured by the data collector 204, such as the voltage waveform data or current waveform data measured by the edge device 201 (or the metering device 118). The utility grid data storage 222 can store timestamps of when the data are logged or stored in the data repository 220. The utility grid data storage 222 can store processed electrical data. In some cases, the utility grid data storage 222 can include information related to components or devices within the utility grid 100, such as the identifier of the edge devices 201 or the geographical location of the edge devices 201.

The identifier storage 224 can include, store, or maintain identifiers, values, or tags representing components or devices within the utility grid 100. For example, the identifier storage 224 can store the identifiers of metering devices 118 or the edge devices 201. The identifier storage 224 can store the identifiers of transformers. The identifier storage 224 may store the identifier of the geographical areas or locations. The identifier storage 224 may store the identifier of the application developer device 242. The identifier can be used to verify the identity of the devices within the network 140.

The configuration storage 226 can include, store, or maintain configurations of components within the system 200. For example, the configuration storage 226 can store the configurations of the edge devices 201. The configuration storage 226 can store the configurations of the applications. The configuration storage 226 can store the configurations of the data processing system 150, in some cases. The configurations can be updated by authorized devices or personnel, including the administrator or the utility operator, for example. The configuration of the application may include or refer to parameters or settings of the application. The configuration of the edge devices 201 may include hardware or software support for the installation of the applications, among other settings.

The attribute storage 228 can include, store, or maintain the local environment attribute. The local environment attribute may be associated with the location of the edge device 201 on the utility grid 100. The local environment attribute can refer to a characteristic or feature associated with a particular location on the utility grid 100. The local environment attribute can include one or more factors, such as weather conditions, power demand patterns, voltage levels, grid congestion, or any other relevant parameter that characterizes the environment at the location of the edge device 201. In some cases, the local environment attribute may include the physical location of the edge device 201, the topology, connectivity characteristics, or neighboring devices of the edge device 201, for example.

The policy storage 230 can include, store, or maintain various policies for the application. The policy can include data security policy, (e.g., computational) load balancing policy, deployment policy, configuration management policy, etc. For example, the data security policy can indicate the types of data accessible or receivable by the data processing system 150 from the application executed on the edge device 201. The load balancing policy can govern the computational resource for one or more applications or one or more edge devices 201. The deployment policy can control the deployment of applications to different edge devices 201, which may include compatibility management or managing application deployment in different locations. The configuration management policy may control the adjustability of the configuration of the application.

The application storage 232 can include, store, or maintain the plurality of applications. The application storage 232 can store applications received from third-party application developers (e.g., application developer device 242). The application storage 232 can store applications hosted by the data processing system 150. The application storage 232 can store applications installed or executed on the edge devices 201. The application storage 232 can provide the applications for installation. The application storage 232 can update the application data according to updates from the application manager 206.

The metric storage 234 can include, store, or maintain various metrics generated by the metric generator 210. The metric can include but is not limited to an electricity utilization metric, among other metrics generated by the metric generator 210. The metric storage 234 can be accessible by one or more components of the data processing system 150. The metric storage 234 can be accessible by the application or the machine learning model configured to process the metric to perform pre-configured functions.

The model storage 236 can include, store, or maintain the machine learning models or AI models. The model storage 236 can receive and store the models generated by the model manager 208. The model storage 236 can be accessed by the one or more components of the data processing system 150 to store, update, or otherwise utilize the models.

The GUI storage 238 can include, store, or maintain GUI-related components. For example, the GUI storage 238 can store icons, images, interactive elements, or other types of data for generating the GUI for display via a display device. The GUI storage 238 can be accessed by the GUI generator 212 to generate the GUI. The GUI storage 238 can store generated GUI from the GUI generator 212. The GUI storage 238 may store GUI generated or created for individual applications.

The action storage 240 can include, store, or maintain various actions selectable or executable by the action manager 216 or by the grid controller 218. The actions can include or correspond to executable codes, instructions, or commands for execution by the action manager 216 or the grid controller 218. The actions can be predetermined by the operator or the administrator of the data processing system 150. The action storage 240 may store other types of actions not limited to those discussed herein. The action storage 240 can update the stored actions, such as adding, removing, or changing the actions according to instructions or configurations from the administrator.

In various configurations, a runtime architecture/platform (e.g., runtime environment layer or data structures) for a set of core services and a common data bus (e.g., core bus) can be provided as an illustrative example. The runtime platform can include one or more components similar to the system 200, for example. The runtime platform can include various components configured to perform the features or operations of the runtime platform. The runtime platform can be described in conjunction with the runtime environment 214 of the data processing system 150, for example. For instance, the features of the runtime platform can be performed by the data processing system 150. The runtime platform can provide a set of core services configured to transform electrical sensor readings into grid information. The electrical sensor readings can correspond to measurements by the metering devices 118 or the edge devices 201. For example, a sensor pack (e.g., the sensor pack 248) can include one or more sensors configured to monitor or measure electricity at the edge device 201. Using the sensor pack, raw electrical data (e.g., alternating current (AC) waveform current or voltage data) can be obtained. The set of core services can receive at least one of raw data or Fourier transformed data (e.g., 246) from the sensor pack.

Each core service can provide a stream of information (e.g., the data stream) to other core services, the cloud platform (e.g., the data processing system 150), or other devices in communication with the network (e.g., network 140). The stream of information may include time-series data, such as measurements obtained from sensors of the metering devices 118 or edge devices 201. The stream of information may include event-based information, such as the power outage notification, information associated with a particular event (e.g., fault detection or power outage), or other information related to an event. The information derived from the sensor readings can be defined by the associated data structures per core service. The runtime platform can components that can function synchronously or independently, such as components described in conjunction with at least FIG. 2, for example.

The core bus can include or correspond to the data processing system 150. The core bus can provide, communicate, or relay information between the components of the runtime platform or from the components of the runtime platform to other entities in communication with the core bus. For instance, the core bus can provide information discussed herein to the data processing system 150. In some configurations, the runtime platform can be a part of the data processing system 150, as described in conjunction with FIG. 2, for example. The ML model pretraining (e.g., sometimes referred to as a model pretraining component) can (pre-)train the ML models. The ML model pretraining can be a part of the data processing system 150 (e.g., model manager 208 configured to train the model). The ML model pretraining can involve sending the model to the edge device 201 after training the model. The edge device 201 can manage the model stored locally, such as updating the model according to the datastream or data for updating from the data processing system 150, replacing the model with an updated model from the data processing system 150, etc. Training the model can involve contextualizing the model for the local environment for proper execution, as global information may be available in the cloud (e.g., the data processing system 150). Training the model on the cloud can allow the model to be deployed on the edge device 201 at a relatively faster pace because the model can tune itself to the edge device 201 without performing the training at the edge.

The third-party application vendor may be similar to the application developer device 242, for example. The third-party application vendor can provide applications for deployment. The applications from the third-party application vendor can be submitted or queued for permission. The gatekeeper or permission broker can handle user permissions related to various data sources and resolutions (e.g., waveform versus lower-resolution data) gathered on the edge device 201 or by neighboring devices that communicate with the edge device 201. For example, data or information produced by one application can be shared with another application according to user permission settings. The user can view or manage which applications have access to their data. The gatekeeper or permission broker can prevent applications from storing or taking certain types of data according to the user permission settings. The user permission settings can include, correspond to, or be a part of the data security policy.

The dispatch resolution service can include one or more services, not limited to optimal power flow (OPF) service, vehicle to grid (V2G) service, or other services for the utility grid 100. The OPF service can provide calculations of the state variables of each element of the system (e.g., system 200) or the utility grid 100 to minimize losses while serving all loads at a minimal cost (e.g., optimizing resources for various edge devices 201 or loads). The state variables of each element can refer to, for instance, a power output or a generation capacity of a generator, parameters related to a transformer operation or the transmission lines, the parameters indicative of the configurations of a voltage regulator, load characteristic information, etc. The V2G service can manage the dispatch or distribution of electrical power from at least one EV's battery (or other generators or electrical storage devices connected to the utility grid 100) into the utility grid 100. The dispatch resolution service can receive information regarding detected fault, outages, or other events in the utility grid. The dispatch resolution service can inform the utility operator of the event and recommended actions to resolve the detected event. The eContracts can involve using blockchain to process contracts (e.g., regulatory contracts) sent to or received by the edge device 201. The eContracts can allow virtual power plants and demand-side aggregators access to behind-the-meter devices (e.g., DERs, controllable loads) and bid the devices into wholesale or local markets. This structure can maintain data local and private, and eliminate conflicts between devices, aggregators, and the grid, for example.

The peer-to-peer can involve allowing the neighboring smart grid chips to communicate with each other, such as between edge devices. The peer-to-peer may involve protecting personal identifiable information (PII) or sensitive information, monitoring or controlling network traffic, or validating requests for information. The functionality of the peer-to-peer can be used to optimize the communication of data from the meters and allow autonomous operations at the grid edge (e.g., at the edge device 201). The peer-to-peer can allow devices to obtain and use information from neighboring devices, for example.

For example, the peer-to-peer can provide the edge device 201 with a communication path to other edge devices 201 for communicating certain types of information with each other based on the applications installed on the edge devices 201. For similar applications installed on the edge devices 201, the edge devices 201 may share information with each other for processing or analysis. For different types of applications installed on different edge devices 201, the edge devices 201 (using the applications) can share information to one another to cause at least one action to be performed by the other application (e.g., the first application sharing or outputting information to the second application).

In some cases, the edge devices 201 installed with at least one application to share information with other edge devices 201 can be selected by the data processing system 150. For example, the data processing system 150 may select a subset of edge devices 201 for installing the application. The subset of edge devices 201 may be randomly selected or based on parameters related to the utility grid 100, such as their transformer group, whether EV charging occurs at the respective edge device 201, etc. The data processing system 150 can reduce or minimize the number of installations of the application by selecting the subset of edge devices 201 to install the application. The data processing system 150 may install different applications on different edge devices 201 to load balance processing because edge devices 201 on the same circuit or nearby may be performing redundant operations or collecting redundant information, for example.

The DER dispatch can use stochastic optimization to determine optimal actions for DERs to take, given at least one of but not limited to price signals, distribution system operator (DSO) signals, user preferences, or power flow constraints. The DER dispatch can allow the utilities to satisfy predefined criteria or obligations according to a specification.

The direction from central system can involve managing actions for the runtime platform. The DER communication (e.g., DER communication component) can involve managing the communication between the smart grid chip and local DERs (e.g., the DER device). The DER communication can allow data and status gathering from the DER as well as its control, either by the smart grid chip or using the chip as a gateway that passes on control information from another entity, such as a virtual power plant. The DER communication can ensure that power flow constraints from the utility are prioritized. The DER communication can ensure that DER controls are optimized based on these constraints. Multiple protocols can be supported, including heartbeat functionality, e.g., to alert devices to disconnection from the central system

The DER device can include a device configured to generate or store electricity, such as a solar PV system, energy storage system, distributed generator, etc. The resource management can manage resources on the network storage.

The digital fingerprint can involve or provide at least one of but not limited to fit RMS error (RMSE) mean, fit RMSE standard deviation, fit mean absolute error (MAE), fit amplitude mean RMS, fit amplitude standard deviation, fit frequency mean, fit frequency standard deviation, standard deviation, skewness, kurtosis, sum, sum log, largest harmonic, largest harmonic value, largest harmonic phase shift, second largest harmonic, second largest harmonic value, second largest harmonic phase shift, total harmonic distortion mean, total harmonic distortion median, total harmonic distortion standard deviation, total harmonic distortion 90th quantile, total harmonic distortion 80th quantile, or total harmonic distortion 10th quantile.

The DSP engine can involve or provide at least one of but not limited to phase angle of current from voltage, RMS of current (I-RMS), RMS of voltage (V-RMS), apparent power (S), active power (P), reactive power (Q), power factor (pf), energy (E), total harmonic distortion of voltage (V-THD), total harmonic distortion of current (I-THD), change in voltage over change in the active power (dV/dP), or change in voltage over change in reactive power (dV/dQ). The local storage can store information from the DSP engine.

The network storage can store various information for the components of the runtime platform, such as electricity captured the sensor pack, processed information, etc. The anomaly detection can involve or provide at least one of but not limited to 0.5 seconds of V waveform centered on an anomaly, anomaly “magnitude” (e.g., mean (over all windows within anomaly time span) of the sum of the log(FFT magnitude)), anomaly duration, anomaly endpoints, or anomaly “z-score” (e.g., statistical measure of how anomaly compares to historic voltage data). The anomaly classification can include or involve at least one of but not limited to anomaly class (e.g., a 7-value array with values between 0-1; one or more of the 7-value array can be non-zero), such as sag, swell, interruption, flicker, oscillatory transient, harmonics, or notch.

The disaggregation can involve the ability to determine the operational states and input or output of DER by sampling voltage or current that reflects possibly multiple DERs as well as other loads. The EV disaggregation can involve using data measured from the voltage or current at the total load (e.g., including behind-the-meter-DERs) or status information sent from the EV charger. The EV disaggregation can determine when an EV is charging. The PV disaggregation can involve using data measured from the voltage or current at the total load (e.g., including behind-the-meter-DERs) or status information sent from the PV inverter. The PV disaggregation can determine when a solar array is producing power, for example.

The weather service (e.g., weather service component) can receive or provide weather information, such as to the core bus (e.g., the data processing system 150) or for storage in the local weather data storage. The local weather data storage can store weather information from the weather service. The load forecasting can involve building machine learning models that predict the demand at subsequent time intervals or instances in user-defined increments (e.g., every 1 minute, 30 minutes, or 1 hour). The load forecasting can be used for local power flow management. The cloud-based weather service can manage the data from the satellite or a weather service device (e.g., from the National Oceanic and Atmospheric Administration (NOAA), or other services) to provide weather-related information to the weather service. The weather service can receive the data from the cloud-based weather service to provide the weather information, including current, historical, or predicted weather conditions. For instance, the weather service can periodically or intermittently ping the cloud-based weather services for local historical and forecasted weather data that can be ingested by other core services and applications. The weather service can provide the weather information to the edge device 201 or the data processing system 150 for forwarding to the edge device 201. The edge device 201 can receive the weather information from the weather service using or via at least one application (e.g., third-party application) or at least one API (e.g., third-party API) configured to communicate with the weather service or relay weather information from the data processing system 150, for example. In some arrangements, the weather service can be a part of the system 200 in communication with the one or more components of the network 140.

By implementing or leveraging the SGDOP (e.g., the system 200), the systems and methods (e.g., the data processing system 150 operated with or connected to the edge devices 201, among other network devices) can provide differentiated network traffic management based on the mode of operation, such as the discovery or live operation of an application. The systems and methods can provide at least one of, for example, service architecture on a chip (e.g., processor or device) facilitating secure and safe third-party interaction with data, service architecture that allows multiple entities to request DER interactions with the utility grid 100, which the combination of services can resolve conflicts, utilize utility rules to understand the hierarchy of operation constraints, dispatch signals to DERs, monitor DER status, or provide relatively instant, or service architecture in the cloud that can facilitate application development, testing, and development (e.g., data science development as a service).

In some cases, the systems and methods can include other methods or means of accomplishing similar results, such as at least one of, but not limited to optimize code for core services to leverage the central processing unit (CPU) compute surface of existing grid metering infrastructure, subvert the metering device 118 (e.g., entirely) and leverage a device inside the control panel to perform similar electrical measurements, provide a secure connectivity platform to the existing metering platform to any local compute surface (e.g., router, gateway, or EV controller, among others), reconfiguration of the system design with the ability to configure levels of control and intelligence from certain electrical behaviors defined or predetermined a priori to rules or models that trigger actions on higher levels of control (e.g., feeder or substation), flip the paradigm by thinning out the edge or core service functionality and instead stream compressed data to a central system (e.g., cloud computing device or on-premise data center), post-process the data for insights (e.g., pattern detection of anomalies, classification of events or device types, predictive maintenance of equipment, etc.), and deploy various actions and configurations to nodes based on the centralized insights, or define a protocol for energy transactions and enable secure transactions between nodes. The nodes can include configurable capabilities and objective functions to optimize.

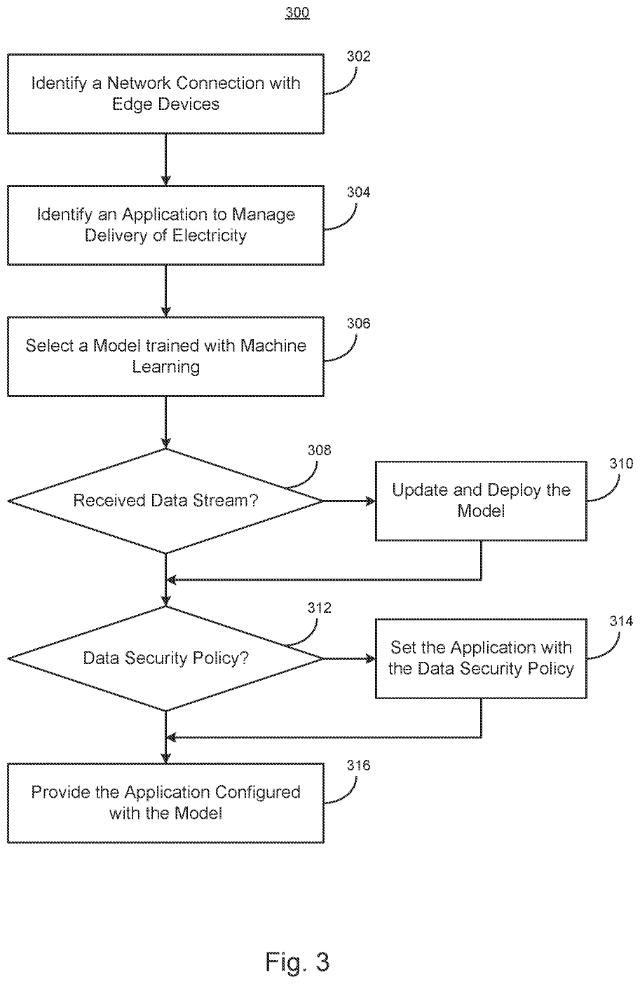

FIG. 3 depicts a flow diagram of an example method 300 for a smart grid distributed operations platform. The example method 300 can be executed, performed, or otherwise carried out by the one or more components of the utility grid 100 (e.g., computing device, metering device 118, data processing system 150, or other devices), the system 200 (e.g., data processing system 150, edge device 201, or application developer device 242), or computing device 500, etc. Although the steps of the method 300 are shown to be performed by one of the data processing system 150, certain steps discussed herein can be performed by other devices, such as one of the edge device 201 or a cloud computing device. The method 300 can include identifying a network connection with edge devices, at ACT 302. At ACT 304, the method 300 can include identifying an application to manage delivery of electricity. At ACT 306, the method 300 can include selecting a model trained with machine learning. At ACT 308, the method 300 can include determining whether a data stream is received. At ACT 310, the method 300 can include updating and deploying the model. At ACT 312, the method 300 can include determining whether there is a data security policy. At ACT 314, the method 300 can include setting the application with the data security policy. At ACT 316, the method 300 can include providing the application configured with the model.

In further detail, at ACT 302, the data processing system can identify a network connection with edge devices. The data processing system can identify the network connection with a plurality of edge devices located on the electricity distribution grid. Each of the edge devices can include a processor and a memory. For example, the edge device can include a GPU configured to process collected data, thereby combining metrology and GPU processing capability to enable distributed edge computing or learning. The edge device may include features similar to a metering device. In some cases, the edge device may correspond to the metering device. The edge device may be a client device operated by a user. The data processing system can identify edge devices that established a connection with the data processing system, for instance, to request or download at least one application from the data processing system or to access an application hosted on the data processing system.

At ACT 304, the data processing system can identify an application to manage the delivery of electricity. The data processing system can identify the application based on a configuration associated with the edge devices. The configuration can indicate at least one of but not limited to the hardware or software compatibility or support, the type of function to be performed by the application, or other device information, as an example. The data processing system can identify an application configured to perform a function according to the configuration, such as but not limited to managing the delivery of electricity via the electricity distribution grid. In some cases, the data processing system can identify multiple applications configured to perform similar functionalities.

The data processing system may select the application automatically in response to identifying the network connection with the edge devices. For example, the data processing system can receive an instruction from an administrator to push at least one application for installation or execution on the edge devices. In some cases, the data processing system may initiate the process of identifying at least one application for installation on the connected edge devices in response to receiving an indication that the application (with a certain functionality) is desired, for instance, to optimize the electricity delivery in the grid, identify a fault or outage in the grid, or monitor events within the grid. In such cases, the data processing system can select at least one application from a pool or list of applications (e.g., in a marketplace) for installation on the edge devices. In some cases, the data processing system can provide a list of applications satisfying the configuration of the edge devices for selection by the user or the administrator, where at least one application can be selected from the list.

At ACT 306, the data processing system can select a model trained with machine learning. The data processing system can select a model from a plurality of models that are trained with at least one suitable machine learning technique based on the local environment attribute associated with a location on the electricity distribution grid at which the plurality of edge devices are located. The local environment attribute can refer to a characteristic or feature associated with the location of the edge device(s). The edge devices can be associated with a similar local environment attribute, for instance, if the edge devices receive electricity from the same transformer or are at a similar geographical location. Individual edge devices may be associated with different local environment attributes according to their location, connection to secondary transformers, etc. The local environment attribute can include but is not limited to weather conditions, power demand patterns, voltage levels, grid congestion, or any other relevant parameter that characterizes the environment at the location associated with the edge devices.

The model may be pre-trained by the data processing system. In some cases, the data processing system can receive a pre-trained model from other computing devices. The model can be pre-trained to contextualize the model for the edge device 201 (or meter) environment, such that the model can be activated upon installation, e.g., for utilization by the application. In some other cases, the data processing system can deploy a model to the edge device for collecting data and training the model at the grid edge.

At ACT 308, the data processing system can determine whether a data stream is received. The data processing system may receive the data stream from at least one of the edge devices. The data stream can include information collected or monitored by the edge device (e.g., sensors of the edge device), such as electrical waveform data, filtered data, processed data, etc. If the data stream is received, the data processing system can proceed to ACT 310. Otherwise, the data processing system can proceed to ACT 312.

At ACT 310, the data processing system can update and deploy the model subsequent to receiving the data stream. The data processing system can update the model selected from the plurality of models based on the data stream. The data processing system can update other models based on the data stream. For instance, the data stream can monitor information related to the function of the application or the model. The data stream can include the electrical information collected over at least one time interval. The data stream can include detected or determined grid events (e.g., electricity demands, faults, outages, or other events related to the delivery of electricity) at the at least one time interval. The data processing system can update or (re-)train the model based on the correlation between the electrical information and the grid events, e.g., to optimize the model for detecting or predicting grid events based on real-time information collected at the grid edge by one or more edge devices.

For example, as part of managing the delivery of electricity, the model can be configured to process or analyze information from the one or more edge devices. In some cases, the model can obtain sensed data captured by multiple edge devices for processing. Subsequent to processing the data, the model can detect a distance from the fault according to the signature or digital fingerprint of electricity (e.g., electricity pattern) from one or more edge devices in response to a power outage notification, detect or predict anomaly, classify an anomaly, detect EV charging event, detect electricity generation event (e.g., from PV system), determine the location of the edge devices in the utility grid, determine the transformer delivering electricity to the edge devices, etc. The data processing system can deploy the model in response to updating (or training) the model for use by the application. The model can be updated for at least one application installed on the edge devices or the application selected for installation on the edge devices.

At ACT 312, the data processing system can determine whether there is a data security policy or whether the data security policy is configured for the application (e.g., by the administrator or the user). The data security policy can be indicated in the configuration of the edge devices. The data security policy can control access to various information from the application including but not limited to access to a type of data, a type of metric, or a type of function for reception or storage by the data processing system. The data security policy can allow for configurable access control for data across various applications, for increased openness and transparency, in some configurations.

For example, the data processing system can determine the data security policy based on the configuration. The data processing system may receive the data security policy from the administrator that is applied to the edge devices. The data processing system may receive personalized or configurable data security policies from individual edge devices, such that different types of data can be filtered or collected for each edge device. If the data security policy is configured for the edge device, the data processing system can proceed to ACT 314. Otherwise, the data processing system can proceed to ACT 316.

At ACT 314, the data processing system can set the application with the data security policy in response to determining the data security policy based on the configuration. For example, the data processing system can configure the application to filter certain data as part of setting the application with the data security policy. The application can filter data transmitted to the data processing system using the data security policy, such that the predefined type of data, the predefined type of metric, or the predefined type of function is not sent or stored on the data processing system.

At ACT 316, the data processing system can provide the application configured with the model. The data processing system can provide the application for execution on the edge devices. The application configured with the model can perform the desired function, such as managing the delivery of electricity via the electricity distribution grid. For example, the executed application can receive a data stream (or sensed information) collected the edge device. The application can input the data stream to the model for processing. The processing power of the model can be based on the hardware or software capability of the edge device. In response to processing the data, the model can provide the desired output for managing the delivery of electricity in the grid, including managing the electrical load balancing, adjusting electrical demand at various time intervals, providing information related to faults or outages to the dispatch service, etc. The edge device can execute the application to perform other operations not limited to those discussed herein.

The data processing system may be configured to send updated data to the edge device for updating the application or model. The data processing system may send the update periodically, in response to an instruction from the administrator, or per request from the edge device. The data processing system may send an updated application or an updated model to the edge devices. The data processing system can iterate the features of the method 300 in response to a request to install another application on the edge device.

The data processing system can identify a second application installed on the plurality of edge devices. The second application may be different from the first application, configured to manage the delivery of electricity or to perform other actions. The data processing system can provide an instruction to cause the application (e.g., the first application) to output data to the second application to perform one or more functions to manage the delivery of electricity via the electricity distribution grid. The data processing system can utilize the first application and the second application as part of a heartbeat message functionality, where the data processing system can receive a message from the first application to cause the second application to perform an action.

For example, the first application can be configured to monitor or analyze the electricity distributed in the utility grid. The first application may detect or predict grid events, such as EV charging, PV electricity generation, electricity demand prediction, etc. The first application can send at least one of the analyzed data or an indication of the grid event to the second application. The second application can be configured to adjust one or more parameters associated with the electricity distribution grid to manage at least one of but not limited to electricity distribution, electricity generation, etc., thereby accommodating changes in electricity demand (e.g., by increasing or decreasing electricity generation) or changes in load balancing strategy, etc.

In another example, a power outage notification can launch the first application app (e.g., distance-to-fault application), where the first application can be configured to output distances from the edge devices to the fault. The output from the first application can launch a second application or be provided as input to the second application. The output from the first application can impact the performance, functionality, or output of the second application, for instance, causing the second application to update the configuration to remedy the fault or notify the operator of the distance to the fault according to the output from the first application. In some cases, the first application and the second application may be from the same application developer. In some other cases, the first application and second application can be provided by different application developers.

The data processing system can identify a second application installed on the plurality of edge devices. The data processing system can update the configuration of the second application based on the output from the application. For example, the configuration can include but is not limited to a grid versus mesh distribution network. The data processing system can update the configuration of the second application in response to receiving the output from the application. In further examples, the first application may be configured to track the meter or application utilization for licensing or resource collection. The first application can output the information related to the meter utilization to the second application to cause the second application to generate a value for resource collection, a metric for tracking the meter utilization, display the resource utilization by the edge devices to the operator, or perform other actions.

In some configurations, the data processing system can provide cross-application functionality by providing the output from the first application to the second application. For instance, the first application can be configured to process information measured by the edge devices. The processed data can be output to the second application, where aspects of the second application may be configured based on the output from the first application to perform its functionality, such as but not limited to the functionalities discussed herein, e.g., fault location determination, anomaly detection or classification, EV charging detection or prediction, etc.

The data processing system can receive a data stream from at least one of the plurality of edge devices. The data processing system may generate an electricity utilization metric based on the data stream. The metric can be represented as values, a table, or a data structure, among other forms computed or processed from the monitored data. For instance, the metrics can include at least one of a voltage harmonic metric, a current harmonic metric, a power metric, or other types of metrics not limited to those discussed herein. The generated metric can be used by the application or the model for the configured or desired function. In some cases, the generated metric can be used as part of training the model.

The data processing system can identify a group identifier linked with the plurality of edge devices. For example, the group identifier can be a value, key, or other types of identifier grouping one or more edge devices into a particular group, such as transformer group, geographical location group, EV charging group, application group, etc. The data processing system can push an update to the plurality of edge devices linked with the group identifier. For example, the edge devices associated with the group identifier can include or be installed with a particular application or have one or more applications utilizing a particular version of the model. The data processing system can push the update to the edge devices to update the application or the model, for example. In some cases, the data processing system may assign a different group identifier to one or more edge devices in response to the update, e.g., separating the edge devices that installed the update from those that did not install the update.

The data processing system can determine, based on a load balancing policy (e.g., computational load balancing policy), to install a second application on a subset of the plurality of edge devices. The load balancing policy can include at least one strategy to balance the computational resources distributed to different applications or edge devices 201. Based on the load balancing policy, the data processing system may determine to install a second application on a subset of the edge devices to satisfy the load balancing policy. The second application may be configured to process at least a portion of the data from the application, such as to balance the computational resources utilized from the application (or by one or more edge devices). The data processing system can provide the second application for installation on the subset of the edge devices.

In some configurations, as part of managing the delivery of electricity, the application can function to determine a distance to a fault responsive to the detection of a power outage notification. The application can determine the distance from the edge device to the fault. The application can perform the determination based on the electrical pattern or characteristics. In some cases, the application may leverage information from other applications installed on other edge devices to perform the determination.

In some aspects, the data processing system can receive the application from a third-party application developer device remote from the data processing system. In certain arrangements, the data processing system can provide a channel for the third-party application developer to provide the application to the edge device(s). The data processing system can validate applications from the third-party application developer. The data processing system can allow the data processing system to provide validated applications to the edge device(s).

The data processing system can provide a list of applications configured to execute on the edge devices via an interface. The interface may be a GUI or an API, for example. The application can include but is not limited to one or more of a first application configured to determine a distance to a fault responsive to detection of a power outage notification, a second application configured to detect an anomaly, a third application configured to detect electric vehicle charging, or a fourth application configured to determine a location of an edge device on the electricity distribution grid based on a fingerprint associated with characteristics of voltage at the location on the electricity distribution grid. The data processing system can receive a selection of the application from the list of the plurality of applications. The data processing system can provide the list of applications to the edge device(s) for user selection or present the list of applications via a display device of the data processing system for selection by the administrator. Responsive to the selection, the data processing system can provide the application for installation on the edge devices. If the list of applications is provided to individual edge devices, the data processing system may provide different selection of applications for the respective edge devices.

The data processing system can provide a runtime environment on the data processing system. The runtime environment can be provided to host one or more applications (e.g., a second application) configured to interface with the application executed on the plurality of edge devices. By interfacing with the application installed on the edge devices, the second application hosted on the runtime environment can receive information from or provide instructions to the application to manage the delivery of electricity in the electricity distribution grid.

FIG. 4 is a flow diagram of another example method 400 for a smart grid distributed operations platform, in accordance with an embodiment. The example method 400 can be executed, performed, or otherwise carried out by the one or more components of the utility grid 100 (e.g., computing device, metering device 118, data processing system 150, or other devices), the system 200 (e.g., data processing system 150, edge device 201, or application developer device 242), or computing device 500, etc. Although the steps of the method 400 are shown to be performed by one of the data processing system 150, certain steps discussed herein can be performed by other devices, such as one of the edge device 201 or a cloud computing device. Certain steps or operations of the method 400 can be performed similarly to or described in conjunction with one or more operations of the method 300 of FIG. 3, for example. The method 400 can include identifying a network connection with the edge devices, at ACT 402. At ACT 404, the method 400 can include identifying an application to manage the delivery of electricity. At ACT 406, the method 400 can include selecting a model trained with machine learning. At ACT 408, the method 400 can include providing the application configured with the model.

In further detail, at ACT 402, the metering system can identify a network connection with edge devices. The data processing system can identify the network connection with a plurality of edge devices located on the electricity distribution grid. Each of the edge devices can include a processor and a memory. For example, the edge device can include a GPU configured to process collected data, thereby combining metrology and GPU processing capability to enable distributed edge computing or learning. The edge device may include features similar to a metering device. In some cases, the data processing system can identify the network connection with one or more edge devices in response to the one or more edge devices establishing the network connection with the data processing system. In some configurations, the data processing system may identify the configuration of the edge device to responsively determine whether to provide at least one application for installation.

At ACT 404, the data processing system can identify an application to manage the delivery of electricity. The data processing system can identify the application based on a configuration associated with the edge devices. The configuration can indicate at least one of but not limited to the hardware or software compatibility or support, the type of function to be performed by the application, or other device information, as an example. The data processing system can identify an application configured to perform a function according to the configuration, such as but not limited to managing the delivery of electricity via the electricity distribution grid. Managing the delivery of electricity can involve various features or functionalities, not limited to load balancing, adjusting electricity demand for power generation (e.g., by the power source of the electricity distribution grid), fault detection, anomaly detection and classification, etc.

At ACT 406, the data processing system can select a model trained with machine learning. The data processing system can select a model from a plurality of models that are trained with at least one suitable machine learning technique based on the local environment attribute associated with a location on the electricity distribution grid at which the plurality of edge devices are located. The local environment attribute can refer to a characteristic or feature associated with the location of the edge device(s). The local environment attribute can include but is not limited to weather conditions, power demand patterns, voltage levels, grid congestion, or any other relevant parameter that characterizes the environment at the location associated with the edge devices. The model can be trained for a predefined function associated with the application, for example. The data processing system can select other models for other applications, where individual models can be trained for utilization by the respective application, in some cases.

At ACT 408, the data processing system can provide the application configured with the model. The data processing system can provide the application for execution on the edge devices. The application configured with the model can perform the desired function, such as managing the delivery of electricity via the electricity distribution grid. For example, the application can input measured or processed data (e.g., the metric) to the model for processing. The model can process the input data and provide the desired output for managing the delivery of electricity in the grid, including updates to the parameters for one or more components of the utility grid, information related to the fault or outages, etc. The data processing system can periodically update the application or the model, e.g., by pushing an update to the one or more edge devices.

FIG. 5 is a block diagram of an example computer system 500. The computer system or computing device 500 can include or be used to implement the data processing system 150, the edge device 201, or its components. The computing system 500 includes at least one bus 505 or other communication component for communicating information and at least one processor 510 or processing circuit coupled to the bus 505 for processing information. The computing system 500 can also include one or more processors 510 or processing circuits coupled to the bus for processing information. The computing system 500 also includes at least one main memory 515, such as a random access memory (RAM) or other dynamic storage device, coupled to the bus 505 for storing information, and instructions to be executed by the processor 510. The main memory 515 can also be used for storing position information, utility grid data, command instructions, device status information, environmental information within or external to the utility grid, information on characteristics of electricity, or other information during execution of instructions by the processor 510. The computing system 500 may further include at least one read only memory (ROM) 520 or other static storage device coupled to the bus 505 for storing static information and instructions for the processor 510. A storage device 525, such as a solid state device, magnetic disk or optical disk, can be coupled to the bus 505 to persistently store information and instructions.

The computing system 500 may be coupled via the bus 505 to a display 535, such as a liquid crystal display, or active matrix display, for displaying information to a user such as an administrator of the data processing system or the utility grid. An input device 530, such as a keyboard or voice interface may be coupled to the bus 505 for communicating information and commands to the processor 510. The input device 530 can include a touch screen display 535. The input device 530 can also include a cursor control, such as a mouse, a trackball, or cursor direction keys, for communicating direction information and command selections to the processor 510 and for controlling cursor movement on the display 535. The display 535 can be part of the data processing system 150, or other components of FIGS. 1-4, among others.

The processes, systems, and methods described herein can be implemented by the computing system 500 in response to the processor 510 executing an arrangement of instructions contained in main memory 515. Such instructions can be read into main memory 515 from another computer-readable medium, such as the storage device 525. Execution of the arrangement of instructions contained in main memory 515 causes the computing system 500 to perform the illustrative processes described herein. One or more processors in a multi-processing arrangement may also be employed to execute the instructions contained in main memory 515. Hard-wired circuitry can be used in place of or in combination with software instructions together with the systems and methods described herein. Systems and methods described herein are not limited to any specific combination of hardware circuitry and software.

Although an example computing system has been described in FIG. 5, the subject matter including the operations described in this specification can be implemented in other types of digital electronic circuitry, or in computer software, firmware, or hardware, including the structures disclosed in this specification and their structural equivalents, or in combinations of one or more of them.

### FURTHER EXAMPLES

The following examples pertain to further embodiments, from which numerous permutations and configurations will be apparent.

Example 1 includes a system, comprising: a data processing system comprising one or more processors, coupled with memory, to: identify a network connection with a plurality of edge devices located on an electricity distribution grid, wherein each of the plurality of edge devices comprise a processor and memory; identify, based on a configuration associated with the plurality of edge devices, an application configured to perform a function to manage delivery of electricity via the electricity distribution grid; select a model from a plurality of models trained with machine learning based on a local environment attribute associated with a location on the electricity distribution grid at which the plurality of edge devices are located; and provide, for execution on the plurality of edge devices, the application configured with the model to perform the function to manage delivery of electricity via the electricity distribution grid.

Example 2 includes the subject matter of Example 1, comprising the data processing system to: determine a data security policy based on the configuration; and set the application with the data security policy, wherein the data security policy controls access to a type of data, a type of metric, or a type of function.

Example 3 includes the subject matter of any of Examples 1 and 2, wherein the application filters data transmitted to the data processing system using the data security policy.

Example 4 includes the subject matter of any of Examples 1 through 3, comprising the data processing system to: identify a second application installed on the plurality of edge devices; and provide an instruction to the application to cause the application to output data to the second application to perform one or more functions to manage delivery of electricity via the electricity distribution grid.

Example 5 includes the subject matter of any of Examples 1 through 4, comprising the data processing system to: identify a second application installed on the plurality of edge devices; and update a configuration of the second application based on output from the application.

Example 6 includes the subject matter of any of Examples 1 through 5, comprising the data processing system to: receive a data stream from at least one of the plurality of edge devices; and generate an electricity utilization metric based on the data stream.

Example 7 includes the subject matter of any of Examples 1 through 6, comprising the data processing system to: receive a data stream from at least one of the plurality of edge devices; update the model based on the data stream; and deploy the updated model to the plurality of edge devices for use by the application installed on the plurality of edge devices.

Example 8 includes the subject matter of any of Examples 1 through 7, comprising the data processing system to: identify a group identifier linked with the plurality of edge devices; and push an update to the plurality of edge devices linked with the group identifier.

Example 9 includes the subject matter of any of Examples 1 through 8, comprising the data processing system to: determine, based on a computational load balancing policy, to install a second application on a subset of the plurality of edge devices; and provide the second application on the subset of the plurality of edge devices.

Example 10 includes the subject matter of any of Examples 1 through 9, wherein the application determines a distance to a fault responsive to detection of a power outage notification.

Example 11 includes the subject matter of any of Examples 1 through 10, comprising the data processing system to: receive the application from a third-party application developer device remote from the data processing system.

Example 12 includes the subject matter of any of Examples 1 through 11, comprising the data processing system to: provide, via an interface, a list of a plurality of applications configured to execute on the plurality of edge devices, the plurality of applications comprising: a first application configured to determine a distance to a fault responsive to detection of a power outage notification; a second application configured to detect an anomaly; a third application configured to detect electric vehicle charging; and a fourth application configured to determine a location of an edge device on the electricity distribution grid based on a fingerprint associated with characteristics of voltage at the location on the electricity distribution grid; receive a selection of the application from the list of the plurality of applications; and provide the application for installation on the plurality of edge devices responsive to the selection.

Example 13 includes the subject matter of any of Examples 1 through 12, comprising the data processing system to: provide a runtime environment on the data processing system to host a second application configured to interface with the application executed on the plurality of edge devices.

Example 14 includes a method, comprising: identifying, by a data processing system comprising a processor coupled with memory, a network connection with a plurality of edge devices located on an electricity distribution grid, wherein each of the plurality of edge devices comprise a processor and memory; identifying, by the data processing system based on a configuration associated with the plurality of edge devices, an application configured to perform a function to manage delivery of electricity via the electricity distribution grid; selecting, by the data processing system, a model from a plurality of models trained with machine learning based on a local environment attribute associated with a location on the electricity distribution grid at which the plurality of edge devices are located; and providing, by the data processing system for execution on the plurality of edge devices, the application configured with the model to perform the function to manage delivery of electricity via the electricity distribution grid.

Example 15 includes the subject matter of Example 14, comprising: determining, by the data processing system, a data security policy based on the configuration; and setting, by the data processing system, the application with the data security policy, wherein the data security policy controls access to a type of data, a type of metric, or a type of function.

Example 16 includes the subject matter of any of Examples 14 and 15, comprising: identifying, by the data processing system, a second application installed on the plurality of edge devices; and providing, by the data processing system, an instruction to the application to cause the application to output data to the second application to perform one or more functions to manage delivery of electricity via the electricity distribution grid.

Example 17 includes the subject matter of any of Examples 14 through 16, comprising: identifying, by the data processing system, a second application installed on the plurality of edge devices; and updating, by the data processing system, a configuration of the second application based on output from the application.

Example 18 includes the subject matter of any of Examples 12 through 17, comprising: receiving, by the data processing system, a data stream from at least one of the plurality of edge devices; updating, by the data processing system, the model based on the data stream; and deploying, by the data processing system, the updated model to the plurality of edge devices for use by the application installed on the plurality of edge devices.

Example 19 includes the subject matter of any of Examples 12 through 18, comprising: determining, by the data processing system based on a computational load balancing policy, to install a second application on a subset of the plurality of edge devices; and providing, by the data processing system, the second application on the subset of the plurality of edge devices.

Example 20 includes the subject matter of any of Examples 12 through 19, comprising: providing, by the data processing system via a graphical user interface, a list of a plurality of applications configured to execute on the plurality of edge devices, the plurality of applications comprising: a first application configured to determine a distance to a fault responsive to detection of a power outage notification; a second application configured to detect an anomaly; a third application configured to detect electric vehicle charging; and a fourth application configured to determine a location of an edge device on the electricity distribution grid based on a fingerprint associated with characteristics of voltage at the location on the electricity distribution grid; receiving, by the data processing system, a selection of the application from the list of the plurality of applications; and providing, by the data processing system, the application for installation on the plurality of edge devices responsive to the selection.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system to provide an electricity distribution grid platform, comprising:
a data processing system comprising one or more processors, coupled with memory, to:
identify a network connection with a plurality of edge devices located on an electricity distribution grid, wherein each of the plurality of edge devices comprise a processor and memory;
identify, based on a configuration associated with the plurality of edge devices, an application configured to perform a function to manage delivery of electricity via the electricity distribution grid;
select a model from a plurality of models trained with machine learning based on a local environment attribute associated with a location on the electricity distribution grid at which the plurality of edge devices are located; and
provide, for execution on the plurality of edge devices, the application configured with the model to perform the function to manage delivery of electricity via the electricity distribution grid.

2. The system of claim 1, comprising the data processing system to:
determine a data security policy based on the configuration; and
set the application with the data security policy, wherein the data security policy controls access to a type of data, a type of metric, or a type of function.

3. The system of claim 2, wherein the application filters data transmitted to the data processing system using the data security policy.

4. The system of claim 1, comprising the data processing system to:
identify a second application installed on the plurality of edge devices; and
provide an instruction to the application to cause the application to output data to the second application to perform one or more functions to manage delivery of electricity via the electricity distribution grid.

5. The system of claim 1, comprising the data processing system to:
identify a second application installed on the plurality of edge devices; and
update a configuration of the second application based on output from the application.

6. The system of claim 1, comprising the data processing system to:
receive a data stream from at least one of the plurality of edge devices; and
generate an electricity utilization metric based on the data stream.

7. The system of claim 1, comprising the data processing system to:
receive a data stream from at least one of the plurality of edge devices;
update the model based on the data stream; and
deploy the updated model to the plurality of edge devices for use by the application installed on the plurality of edge devices.

8. The system of claim 1, comprising the data processing system to:
identify a group identifier linked with the plurality of edge devices; and
push an update to the plurality of edge devices linked with the group identifier.

9. The system of claim 1, comprising the data processing system to:
determine, based on a computational load balancing policy, to install a second application on a subset of the plurality of edge devices; and
provide the second application on the subset of the plurality of edge devices.

10. The system of claim 1, wherein the application determines a distance to a fault responsive to detection of a power outage notification.

11. The system of claim 1, comprising the data processing system to:
receive the application from a third-party application developer device remote from the data processing system.

12. The system of claim 1, comprising the data processing system to:
provide, via an interface, a list of a plurality of applications configured to execute on the plurality of edge devices, the plurality of applications comprising:
a first application configured to determine a distance to a fault responsive to detection of a power outage notification;
a second application configured to detect an anomaly;
a third application configured to detect electric vehicle charging; and
a fourth application configured to determine a location of an edge device on the electricity distribution grid based on a fingerprint associated with characteristics of voltage at the location on the electricity distribution grid;
receive a selection of the application from the list of the plurality of applications; and
provide the application for installation on the plurality of edge devices responsive to the selection.

13. The system of claim 1, comprising the data processing system to:
provide a runtime environment on the data processing system to host a second application configured to interface with the application executed on the plurality of edge devices.

14. A method, comprising:
identifying, by a data processing system comprising a processor coupled with memory, a network connection with a plurality of edge devices located on an electricity distribution grid, wherein each of the plurality of edge devices comprise a processor and memory;
identifying, by the data processing system based on a configuration associated with the plurality of edge devices, an application configured to perform a function to manage delivery of electricity via the electricity distribution grid;
selecting, by the data processing system, a model from a plurality of models trained with machine learning based on a local environment attribute associated with a location on the electricity distribution grid at which the plurality of edge devices are located; and
providing, by the data processing system for execution on the plurality of edge devices, the application configured with the model to perform the function to manage delivery of electricity via the electricity distribution grid.

15. The method of claim 14, comprising:
determining, by the data processing system, a data security policy based on the configuration; and
setting, by the data processing system, the application with the data security policy, wherein the data security policy controls access to a type of data, a type of metric, or a type of function.

16. The method of claim 14, comprising:
identifying, by the data processing system, a second application installed on the plurality of edge devices; and
providing, by the data processing system, an instruction to the application to cause the application to output data to the second application to perform one or more functions to manage delivery of electricity via the electricity distribution grid.

17. The method of claim 14, comprising:
identifying, by the data processing system, a second application installed on the plurality of edge devices; and
updating, by the data processing system, a configuration of the second application based on output from the application.

18. The method of claim 14, comprising:
receiving, by the data processing system, a data stream from at least one of the plurality of edge devices;
updating, by the data processing system, the model based on the data stream; and
deploying, by the data processing system, the updated model to the plurality of edge devices for use by the application installed on the plurality of edge devices.

19. The method of claim 14, comprising:
determining, by the data processing system based on a computational load balancing policy, to install a second application on a subset of the plurality of edge devices; and
providing, by the data processing system, the second application on the subset of the plurality of edge devices.

20. The method of claim 14, comprising:
providing, by the data processing system via a graphical user interface, a list of a plurality of applications configured to execute on the plurality of edge devices, the plurality of applications comprising:
a first application configured to determine a distance to a fault responsive to detection of a power outage notification;
a second application configured to detect an anomaly;
a third application configured to detect electric vehicle charging; and
a fourth application configured to determine a location of an edge device on the electricity distribution grid based on a fingerprint associated with characteristics of voltage at the location on the electricity distribution grid;
receiving, by the data processing system, a selection of the application from the list of the plurality of applications; and
providing, by the data processing system, the application for installation on the plurality of edge devices responsive to the selection.
